(19) United States
(12) Patent Application Publication
(10) Pub. No.: US 2025/0051100 A1
(43) Pub. Date: Feb. 13, 2025

(54) CAUTIONING METHOD, RESTAURANT SYSTEM, RESTAURANT PROCESSING DEVICE, AND STORAGE MEDIUM STORING PROGRAM

(71) Applicant: Kura Sushi, Inc., Osaka (JP)

(72) Inventor: Kunihiko TANAKA, Osaka (JP)

(21) Appl. No.: 18/923,690

(22) Filed: Oct. 23, 2024

Related U.S. Application Data
(63) Continuation of application No. PCT/JP2024/017385, filed on May 10, 2024.

(30) Foreign Application Priority Data
May 22, 2023 (JP) 2023-083900

(51) Int. Cl. B65G 43/02; G06V 20/52; G06V 20/68

(52) U.S. Cl. CPC B65G 43/02; G06V 20/52; G06V 20/68; B65G 2203/0258; B65G 2203/041; B65G 2203/042

(57) ABSTRACT

A cautioning method includes: delivering an item on a conveying path of a conveying device to a target seat; outputting a delivery notification indicating that the item will be delivered to the target seat presently by the conveying device; determining whether a caution state has occurred at each of the two or more seats based on information from a sensor disposed in the restaurant; determining that a caution condition is satisfied when the caution state is determined to have occurred at any seat located upstream of the target seat in a conveying direction of the conveying path after the delivery notification was output; and outputting caution information for alerting a user that an abnormality may have occurred in the item upon determining that the caution condition is satisfied.

### CROSS REFERENCE TO RELATED APPLICATION

This application is a continuation application of International Patent Application No. PCT/JP2024/017385 filed on May 10, 2024, which designated the U.S. and claims the benefit of priority from Japanese Patent Application No. 2023-083900 filed on May 22, 2023. The entire disclosure of the above application is incorporated herein by reference.

### TECHNICAL FIELD

The present disclosure relates to a cautioning method, a restaurant system, a restaurant processing device, and a storage medium storing a program that can be used in a restaurant that conveys items to users by a conveying device.

### BACKGROUND

Conventionally, in a store such as a restaurant that serves items such as sushi, a conveying device to convey items to tables for users as visitors to the store. In such a conveying device, an item can be served to a user by conveying the item to the user by setting the item on the conveying path.

For example, there has been known a configuration of a food management device for managing a food or a beverage housed in a container on a conveying path.

In addition, a user places an order for an item using a portable terminal or the like at each seat in a store such as a restaurant, for example.

### SUMMARY

When an abnormality such as a foreign object approaching an item during conveyance of the item by the conveying device, it is necessary to know that the abnormality may have occurred in order to deal with by users who are related persons such as staffs at the store and customers of the store. However, it is not realistic for such a user to constantly monitor the status of conveyance by the conveying device to check whether any abnormality occurs.

One of the objectives of the present disclosure is to provide a cautioning method, a restaurant system, a restaurant processing device, and a storage medium storing a program for alerting a user that an abnormality may have occurred in an item that is being conveyed on a conveying path.

A first aspect of the present disclosure is a cautioning method including: delivering an item on a conveying path of a conveying device to a target seat among two or more seats that arranged in a restaurant along the conveying path by controlling the conveying device; outputting, in a manner corresponding to the target seat, a delivery notification indicating that the item will be delivered to the target seat presently by the conveying device; determining whether a caution state has occurred at each of the two or more seats based on information from a sensor disposed in the restaurant, the caution state being a state where a foreign object approaches the conveying path; determining that a caution condition is satisfied when the caution state is determined to have occurred at any seat among the two or more seats located upstream of the target seat in a conveying direction of the conveying path after the delivery notification was output; and outputting caution information for alerting a user that an abnormality may have occurred in the item that is conveyed on the conveying path upon determining that the caution condition is satisfied.

With this method, when the caution condition occurs at any seat upstream of the target seat after the delivery notification has been output, a user can be alerted that an abnormality may have occurred in the item that is being delivered on the conveying path.

In a second aspect of the present disclosure, a restaurant system includes: a conveyance control unit that is configured to control a conveying device to deliver an item on a conveying path to a target seat among two or more seats arranged in a restaurant along the conveying path; a detection unit that is configured to detect, at each of the two or more seats, a caution state where a foreign object approaches the conveyance path; a determination unit that is configured to determine that a caution condition is satisfied when the detection unit detects, during delivery of the item, that the caution state has occurred at any seat among the two or more seats that is located upstream of the target seat in a conveying direction of the conveying path; and a warning unit that is configured to output caution information for alerting a user that an abnormality may have occurred in the item that is conveyed on the conveying path when the determination unit determines that the caution condition is satisfied.

Accordingly, a user can be alerted that an abnormality may have occurred in the item being conveyed on the conveying path.

In a third aspect of the present disclosure, the restaurant system according to the second aspect further includes a delivery notification unit that is configured to output, in an output manner corresponding to the target seat, a delivery notification indicating that the item will be delivered to the target seat presently by the conveying device. The determination unit determines that the caution condition is satisfied when the caution state is detected at any seat among the two or more seats that is located upstream of the target seat after the delivery notification unit output the delivery notification.

Accordingly, it is possible to alert a user that an abnormality may have occurred in the item for which the delivery notice has been output.

A fourth aspect of the present disclosure is the restaurant system according to the second aspect, wherein the determination unit determines that the caution condition is satisfied when the caution state is detected at any seat among the two or more seats and when the item is not conveyed.

Accordingly, it is possible to output the caution information even when no item is being conveyed.

A fifth aspect of the present disclosure is the restaurant system according to the second aspect, wherein the detection unit detects the caution state when a foreign object enters a detection area that is defined on a side of the conveying path when viewed in the conveying direction of the conveying path.

Accordingly, it is possible to detect the foreign object entering the detection area located to one side of the conveying path, and therefore to alert a user that an abnormality may have occurred in the item.

A sixth aspect of the present disclosure is the restaurant system according to the fifth aspect, wherein the detection unit includes a sensor that is disposed in each of the two or more seats, and the sensor is configured to measure a physical quantity that varies by the foreign object entering the detection area.

Accordingly, it is possible to detect the caution state with higher accuracy.

A seventh aspect of the present disclosure is the restaurant system according to the fifth aspect, wherein the detection unit includes: a camera that is disposed to have the detection area of at least one of the two or more seats covered by an imaging range of the camera; and an image determination unit that is configured to determine whether the caution state has occurred based on an image captured by the camera.

Accordingly, it is possible to detect the caution state for one or more seats corresponding to an area that is covered by the imaging area of the camera.

An eighth aspect of the present disclosure is the restaurant system according to the fifth aspect, wherein the detection unit includes: a distance measuring sensor that is disposed in association with a group including at least two seats among the two or more seats, the distance measuring sensor being configured to measure a distance to the foreign object that enters the detection area of each of the at least two seats in the group; and a seat identification unit that is configured to identify a seat among the at least two seats where the caution state has occurred based on the distance to the foreign object measured by the distance measuring sensor.

Accordingly, it is possible to detect the caution state at each of the seats using the detection units that are fewer than the number of the seats.

A ninth aspect of the present disclosure is the restaurant system according to the second aspect, wherein the warning unit is further configured to output the caution information in an output manner corresponding to a seat at which the detection unit detects the caution state when the detection unit detects the caution state and when the determination unit determines that the caution condition is satisfied.

Accordingly, it is possible for a user to identify the seat at which the caution state has been detected based on the output caution information.

A tenth aspect of the present disclosure is the restaurant system according to the second aspect, wherein the warning unit is further configured to output the caution information in an output manner corresponding to the target seat when the determination unit determines that the caution condition is satisfied during delivery of the item.

Accordingly, it is possible for a user to identify the seat at which the caution state has been detected based on the output caution information.

An eleventh aspect of the present disclosure is the restaurant system according to the second aspect, wherein the warning unit is further configured to store the caution information in a storage unit in association with information for identifying a seat for which the detection unit detects the caution state when the detection unit detects the caution state and when the determination unit determines that the caution condition is satisfied.

Accordingly, it is possible to use the caution information corresponding to the seat at which the caution state has been detected.

A twelfth aspect of the present disclosure is the restaurant system according to the second aspect, wherein the conveyance control unit is further configured to stop delivering the item when the determination unit determines that the caution condition is satisfied during delivery of the item.

Accordingly, it is possible to increase the possibility of preventing an actual abnormality from occurring in the item being conveyed on the conveying path.

A thirteenth aspect of the present disclosure is the restaurant system according to the third aspect, wherein the conveying device includes a delivery start button provided in a kitchen of the restaurant, the conveyance control unit is configured to control the conveying device to start delivering the item when the delivery start button is operated, and the delivery notification unit is configured to output the delivery notification when the delivery start button is operated.

Accordingly, the delivery notification section outputs the delivery notification when the delivery start button is operated, so that the delivery notification can be reliably output. Therefore, it is possible to accurately detect whether the caution state has occurred after the delivery notification has been output.

A fourteenth aspect of the present disclosure is the restaurant system according to the third aspect, wherein the conveying device further includes an item sensor that is disposed in a boundary portion extending into a dining area from a kitchen of the restaurant, the item sensor is configured to detect the item when the item is conveyed into the dining area from the kitchen, and the delivery notification unit is configured to output the delivery notification when the item sensor detects the item.

Accordingly, upon detecting an item is conveyed from the kitchen into the dining area, the delivery notification unit outputs the delivery notification. Thus, it is possible to reliably monitor the item exposed in the dining area. Thus, it is possible to accurately detect whether the caution state has occurred after the item has entered the dining area.

A fifteenth aspect of the present disclosure is the restaurant system according to the third aspect, wherein the conveying device further includes a transfer conveying path that is disposed in a kitchen of the restaurant to be connected to a start edge portion of the conveying path, the transfer conveying path is configured to transfer the item to the conveying path, the conveying device further includes an item sensor that is configured to detect the item that is transferred from the transfer conveying path to the conveying path, and the delivery notification unit is configured to output the delivery notification when the item sensor detects the item.

Accordingly, when the item sensor detects an item being transferred from the transfer conveying path to the conveying path, the delivery notification unit outputs a delivery notification. Therefore, it is possible to reliably monitor the products that are transferred onto the conveying path and conveyed into the dining area. As a result, it is possible to accurately detect whether the caution state has occurred on the item that is entering the dining area.

A sixteenth aspect of the present disclosure is the restaurant system according the third aspect, wherein the conveying device includes a weight sensor disposed in the conveying path, the weight sensor is configured to detect the item when the item is placed on the conveying path, and the delivery notification unit is configured to output the delivery notification when the weight sensor detects the item.

Accordingly, when an item is placed on the conveying path, the delivery notification unit outputs the delivery notification. Therefore, the delivery notification can be reliably output. Therefore, it is possible to accurately detect whether the caution state has occurred after the delivery notification has been output.

### BRIEF DESCRIPTION OF DRAWING

FIG. 1 is a diagram illustrating an example of a conveying device in a restaurant in which a restaurant system in the present embodiment is installed.

FIG. 2 is a plan view schematically illustrating the restaurant system.

FIG. 3 is a cross-sectional side view showing a schematic diagram of a detection area in the restaurant system.

FIG. 4 is a block diagram of the restaurant system.

FIG. 5 is a diagram illustrating an example of user information used by an information processing device.

FIG. 6 is a flowchart illustrating one example of an operation by the information processing device.

FIG. 7 is a flowchart of one example of a caution condition determination process performed by the information processing device.

FIG. 8 is a diagram illustrating one example of a screen in which a notification based on the caution information is performed by the notification device.

FIG. 9 is a flowchart of one modified example of a caution condition determination process performed by the information processing device.

FIG. 10 is a diagram illustrating another example of a screen in which a notification based on the caution information is performed by the notification device.

FIG. 11 is a block diagram of a restaurant system according to a second embodiment.

FIG. 12 is a plan view schematically illustrating the restaurant system.

FIG. 13 is a block diagram of a restaurant system according to a modification to the second embodiment.

FIG. 14 is a plan view schematically illustrating the restaurant system.

FIG. 15 is a plan view illustrating an overview of a restaurant system according to one modification to the first embodiment of the present disclosure.

FIG. 16 is a flowchart showing another modified example of a caution condition determination process performed by the information processing device according to the first embodiment of the present disclosure.

FIG. 17 is a schematic diagram of a computer system in the above embodiment.

FIG. 18 is a block diagram of the computer system.

FIG. 19 is a plan view showing an overview of a restaurant system with a conveying device having a transfer conveying path.

### DESCRIPTION OF EMBODIMENTS

Hereinafter, embodiments of a restaurant system and the like will be described with reference to the drawings. In the embodiment, since the components having the same reference numerals perform the same operation, the description may be omitted again.

The terms used in the following are generally defined as follows. The meanings of these terms should not always be construed as indicated herein, but should be interpreted in light of their explanations, for example, if they are separately described below.

For a certain matter, an identifier is a character or code that uniquely indicates the matter. The identifier is, for example, an ID, but the type of the identifier does not matter as long as the identifier is information from which the corresponding matter can be identified. That is, the identifier may be the name of the thing itself that it indicates, or it may be a combination of signs or symbols so that they uniquely correspond.

Acquisition may include acquiring matters input by a user or the like, or may include acquiring information stored in another device. Acquiring information stored in the other device may include acquiring information stored in the other device via API or the like, or may include acquiring the contents of document files (including the contents of web pages) provided by the other device. Further, it may include acquiring information in a format different from the original information based on the original information, such as acquiring information by performing optical character reading for the image file.

Further, a so-called machine learning method may be used to acquire information. For example, the use of machine learning methods can be done as follows. That is, a learner (learning information) with a specific type of input information as input and output information of the type to be acquired as output is created using a machine learning method. For example, two or more sets of input information and output information are prepared in advance, the two or more sets of information are given to a module for creating a machine learning learner to create a learner, and the created learner is stored in the storage unit. The learner can also be called a classifier. The machine learning method may be, for example, deep learning, random forest, SVM, or the like. Machine learning may also use functions in various machine learning frameworks such as fast Text, tinySVM, random forest, TensorFlow, and various existing libraries. Acquiring information using such a learner is sometimes called acquisition by machine learning.

Further, the learner is not necessarily limited to ones obtained by machine learning. The learner may be, for example, a table showing a correspondence between an input vector based on input information and the like and output information. In this case, output information corresponding to a feature vector based on input information may be acquired from a table. Alternatively, a vector approximating to a feature vector based on input information may be generated using two or more input vectors in the table and a parameter for weighting each input vector may be generated. Then, a final output information may be acquired using the output information corresponding to each input vector used for generation and parameters. Acquiring information using such a learner may be sometimes called acquisition using correspondence. Further, the learner may be, for example, a function representing the relationship between an input vector based on input information or the like and information for generating output information. In this case, for example, information corresponding to the feature vector based on the input information may be calculated by a function, and output information may be acquired using the obtained information. Acquiring information using such a learner may be sometimes called acquisition using a function.

Information output is a concept that includes displaying on a display, projecting using a projector, printing with a printer, sound output, transmission to an external device, storage on a storage medium, delivery of processing results to other processing devices or other programs, and the like. Specifically, for example, enabling images of information on a web page, sending the information as an e-mail or the like, and outputting the information for printing, and the like may be included.

Acceptance of information is a concept that includes acceptance of information input from an input device such as a keyboard, a mice, a touch panel, etc., the reception of information transmitted from another device via a wired or wireless communication line, and the acceptance of information read from a storage medium such as an optical disk, magnetic disk, semiconductor memory, etc.

For various types of information stored in an information processing device or the like, updating is a concept that includes not only changing the stored information, but also adding new information to the stored information, or erasing part or all of the stored information.

### EMBODIMENT

The overview of the present embodiment is as follows. A restaurant system of this embodiment is used in a restaurant (or a store) that uses a conveying device that conveys items placed on a conveying path to a pre-specified destination among two or more seats that are arranged along the conveying path. The restaurant system is configured to determine whether a predetermined caution condition is met based on an operating status of the conveying device and a detection result by a detection unit that a caution state has occurred in which a foreign object has approached the conveying path, and, if the caution condition is determined to be met, to output caution information. By outputting the caution information, it is possible to draw attention to the possibility that there is an abnormality in the item being conveyed along the conveying path.

The caution condition may be met when the caution state is detected at any of the seats upstream of the destination seat (i.e., the target seat) during the conveyance of the item. The caution condition may also be met when occurrence of the caution state is detected after a delivery notification is output. The delivery notification indicates that an item will soon be conveyed to the target seat. The caution condition may also be met when occurrence of the caution state is detected while no items are being conveyed.

The caution state may include a state in which a foreign object entered a detection area on a side of the conveying path when viewed in a conveying direction of the conveying path. A detection unit may be, for example, a sensor that is disposed in each of two or more seats and is configured measure a physical quantity that varies by a foreign object enters the detection area. The detection unit may include a camera and an image determination unit. The camera is disposed to have the detection area of at least one of the two or more seats covered by its imaging range. In addition, the detection unit may include a distance measuring sensor that is disposed for at least two of the two or more seats to detect a distance to a foreign object that has entered the detection area of each corresponding seat. The detection unit further includes a seat identification unit that identifies the seat for which the caution state occurred. The detection unit may include a camera and an image determination unit. The camera is disposed to have an area near the conveying path for at least one seat covered by its imaging range.

The restaurant system may output the caution information in an output manner corresponding to the seat where the caution state was detected or corresponding to the target seat (i.e., a delivery destination).

When the determination unit determines that the predetermined caution condition is met, delivery of the item may be stopped (which may include, for example, suspending or executing a return operation, etc.).

Hereinafter, one example of a restaurant system, an information processing device used therein, and the like will be described.

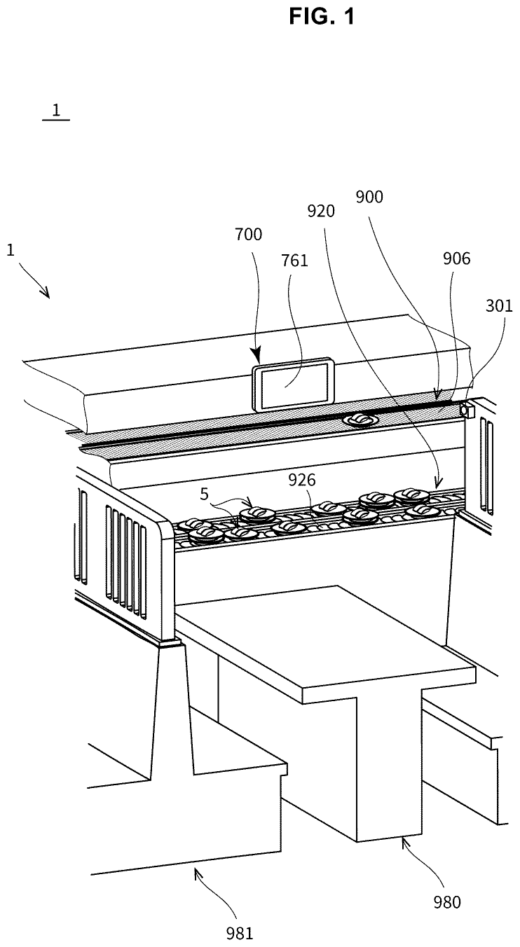

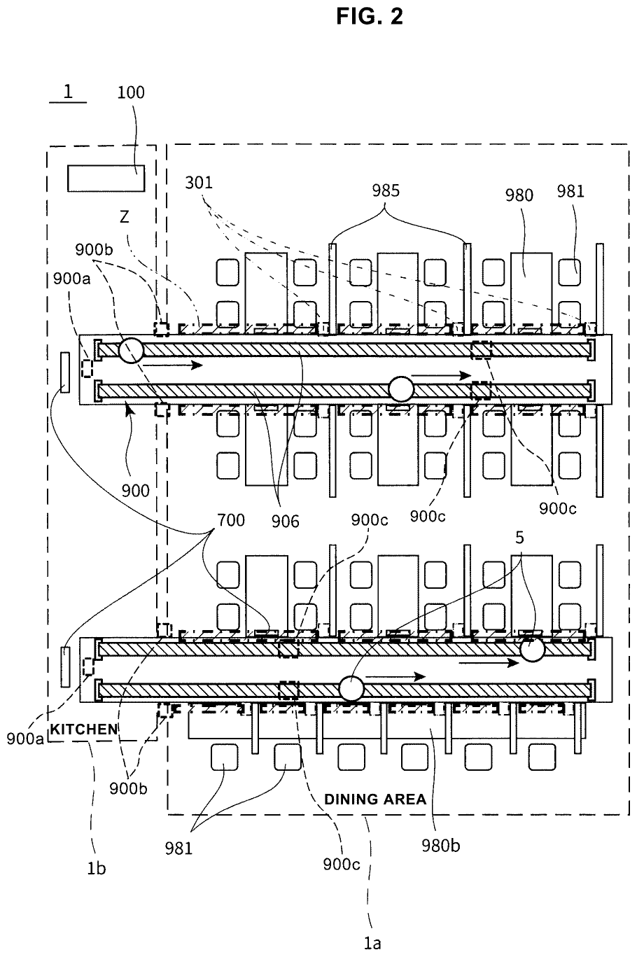

FIG. 1 is a diagram illustrating an example of a conveying device 900 in a restaurant in which the restaurant system 1 in the present embodiment is installed. FIG. 2 is a plan view showing an overview of the restaurant system 1.

The restaurant system 1 according to the present embodiment is used in a building such as a restaurant or a store, for example. FIG. 1 shows a part of fixtures and the like. FIG. 2 shows an example of the conveying device 900 in a building such as a restaurant. The restaurant may be, for example, a so-called conveyor belt sushi restaurant. The building in which the restaurant system 1 is used may be a restaurant of another field or business type or a building that is not a restaurant. In addition, an item served to a user may be a free item or a paid item.

In the present embodiment, the item is a food, a beverage, or a drink such as sushi, for example. For example, the item may be a dish such as nigiri sushi, hand-rolled sushi, or other plates. Further, the food and the drink may include a beverage, a confectionery, a containerized food, a packaged food, and the like. Further, the item may be any other item having value than foods and drinks such as a gift or goods.

In the present embodiment, the restaurant system 1 allows a user who is a visitor to place an order for an item at each seat. Further, in the restaurant system 1, the item may be conveyed to the seat of the user by the conveying device 900.

Here, “seat” is a concept meaning a seat or table used by a user (a customer) to whom the item is served. One seat corresponds to, for example, a customer group of one or more users who purchase an item (the customer group may include one or more users and may be a single user). For example, when a customer group formed of a plurality of users comes to a restaurant, and the customer group is guided to one table in the store, the one table corresponds to a seat. Further, for example, when a customer group with only one person comes to a restaurant, and the customer group is guided to one counter seat in the restaurant, the one counter seat corresponds to a seat. However, the seat is not necessarily limited to an actual seat or table. The seat may be other things indicating a purchaser, an ordering person/entity, a provider, or the like for the item as corresponding to a group formed of one or more users. Such a seat may be real or virtual. In other words, the “seat” is a concept that indicates a unit to which the item is provided and the price of the item is charged. In the following description, a seat corresponding to such a user (the customer group) may simply be referred to as a user. That is, when an item is provided to a seat corresponding to a user (a customer group), it may be simply expressed as “an item is provided to a user”.

The restaurant system 1 includes the conveying device 900, a lower conveying device 920, an information processing device 100, and a notification device 700.

The restaurant in which the restaurant system 1 is used includes, for example, a dining area 1a where users eat and drink, and a kitchen 1b where items are cooked and prepared. In the dining area 1a, for example, tables 980 and seats 981 are provided for users to eat and drink. As a table 980, a counter table 980b at which users in a row can eat and drink may be used.

The notification device 700 is, for example, a reception terminal disposed at each seat. However, one notification device 700 may be shared with two or more seats. Further, two or more notification devices 700 may be used at one seat. Further, the notification device 700 may be disposed in the kitchen 1b so that staffs of the restaurant can use the notification device 700.

In the present embodiment, one customer group can order items or the like using the notification device 700 that is disposed at the seat for the group. The notification device 700 has a notification display 761 that is a screen such as a touch panel.

In the drawing, although a tablet-type information terminal device is used as the notification device 700, a portable information terminal device, a personal computer (PC), or the like may also be used as the notification device 700.

In the restaurant system 1, using a so-called electronic menu displayed by the notification device 700, a user at a seat can place an order for the item 5 or the like. For such a configuration for accepting an order for the item 5, a publicly-known method can be used, for example. For example, the information processing device 100 accepts an order from each seat based on a user's order operation onto the notification device 700 or the like at the seat, and transmits the contents of the order to a terminal or the like provided in the kitchen 1b (not shown).

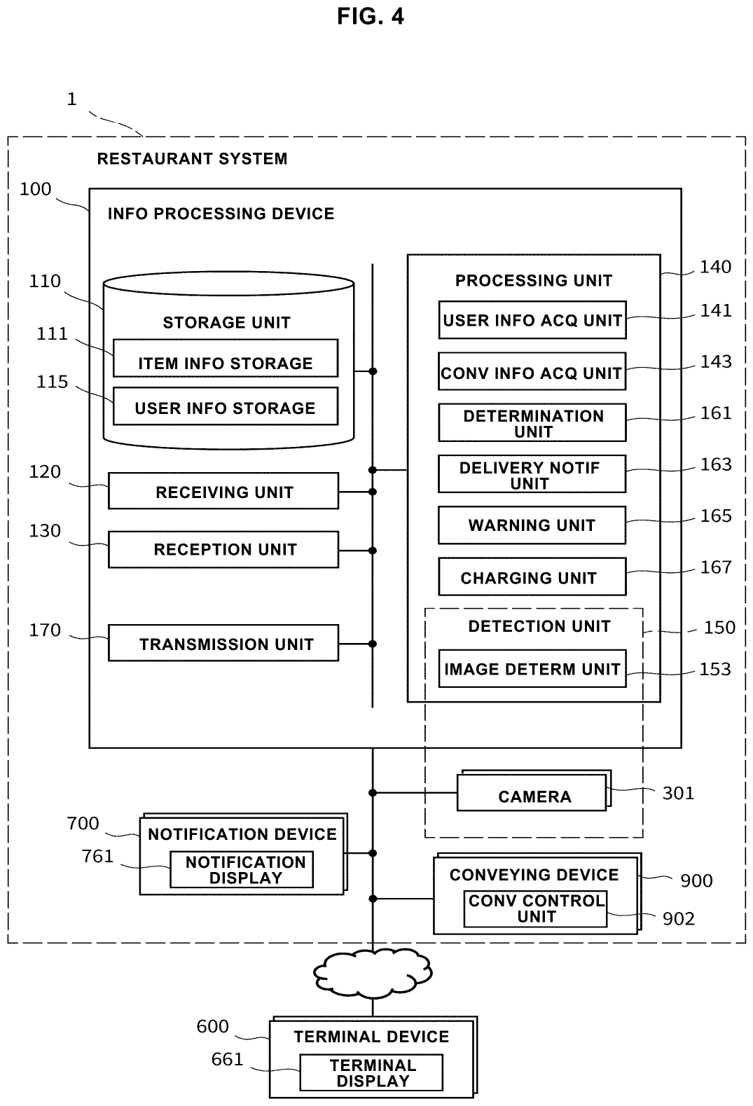

In the present embodiment, the restaurant system 1 may be used together with a terminal device 600 (shown in FIG. 4) that communicates with the information processing device 100 via a network, for example. The terminal device 600 may be considered to be a part of the restaurant system 1, or may be considered to be not included in the restaurant system 1. The terminal device 600 is, for example, used by a user. That is, customers of the restaurant may receive services from the restaurant system 1 using terminal devices 600 or the like. In this case, the customer group may also order items using one or more terminal devices 600 owned by the customers of the group. In this case, for example, a configuration of the restaurant system as described in JP2021-015529A, which is incorporated herein by reference, may be used.

As the terminal device 600, for example, a portable terminal device such as a so-called smartphone can be used. The terminal device 600 includes a terminal display 661 (as shown in FIG. 4) that is a screen such as a touch panel. Alternatively, a personal computer (PC) such as a tablet-type information terminal device and a laptop computer may be used as the terminal device 600.

The terminal device 600 may be used by, for example, a restaurant employee such as a hall staff. That is, the restaurant staff can use the restaurant system 1 using the terminal device 600. For example, a restaurant staff may be able to accept an order by transmitting information such as order details from each seat to the information processing device 100 or the like using the terminal device 600.

In the present embodiment, the notification device 700 receives information output (transmitted) from the information processing device 100, and based on the received information, the notification display 761 displays information or the like. The notification device 700 displays information or the like based on alert information when the alert information is input into the notification device 700 and the terminal device 600. Note that the notification device 700 is capable of outputting audio sound, light, and the like, and may output audio sound, light, or the like based on the output alert information. When the terminal device 600 is used, display or the like may be performed on the terminal display 661 based on the information received from the information processing device 100, similarly.

In the restaurant system 1, devices can communicate with each other via a network such as, for example, a local area network or the Internet, but are not necessarily limited thereto. The number of the devices in the restaurant system 1 may not be limited, and other devices may be used in the restaurant system 1.

The lower conveying device 920 includes a conveying path 926 on which plates are conveyed. An item 5 such as sushi is placed on the plate. The conveying path 926 is laid in the dining area 1a so that plates are conveyed along the tables 980. The conveying path 926 is formed using, for example, a crescent chain having a flat upper surface, but is not limited thereto. The conveying path 926 is configured to convey the plates in a predetermined conveying direction to circulate along tables 980 between the dining area 1a and the kitchen 1b. In FIG. 2, the lower conveying device 920 is not illustrated.

The conveying device 900 is provided above the lower conveying device 920. However, the vertical position of the conveying device 900 relative to the lower conveying device 920 is not necessarily limited to this.

The conveying device 900 has a conveying path 906 disposed above the conveying path 926. Plates carrying the items 5 may be placed on the conveying path 906. The conveying path 906 is laid in the dining area 1a so that plates are conveyed along the tables 980. The conveying path 906 may include, for example, a belt on which plates or the like can be placed, but may also be formed of a plurality of holders in the conveying direction on which plates can be placed.

The conveying path 906 conveys the plates in a predetermined conveying direction (indicated by the arrow in FIG. 2) to deliver an item to a target one of the tables 980 in the dining area 1a. The conveying path 906 is arranged to pass through spaces between the seats arranged on both sides of the conveying path 926 in a plan view, but is not necessarily limited to this. In the dining area 1a, a plurality of conveying paths 906 are provided. One end of each conveying path 906 is located in the kitchen 1b.

The conveying device 900 is driven by a conveyance control unit 902 (shown in FIG. 4) that controls the operation of the conveying device 900. The conveyance control unit 902 is, for example, a control circuit that controls a motor (not shown) for driving the conveying path 906. The conveyance control unit 902 is configured to control the conveying path 906 based on the control by the processing unit 140 of the information processing device 100, which will be described later.

The conveying path 906 is driven by the conveying control unit 902 to convey the plates on which items 5 such as sushi are placed from the kitchen 1b to the dining area 1a. That is, the conveying path 906 conveys plates with sushi or the like, which is an item 5, from the upstream side to the downstream side. When viewed from a certain point on the conveying path 906, the upstream is a side where the item 5 is approaching, and the downstream is a side where the item 5 is moving away. The conveying path 906 may extend in a straight line or in a curved line.

In this embodiment, the conveying device 900 provides an item 5 and the like by identifying the seat (i.e., the target seat) to which the item 5 is to be provided. In other words, the conveying device 900 is configured to deliver the item 5 etc. to the specified destination (the target seat). The target seat (a recipient) can be identified, for example, based on instructions from an employee in the kitchen area 1b, but the target seat may also be identified based on information output from the information processing device 100.

As shown in FIG. 2, the conveying device 900 further includes a delivery start button 900a in the kitchen 1b. The delivery start button 900a may be a mechanical push button or an image displayed on a predetermined display. In addition, the delivery start button 900a may be displayed on a notification device 700, which will be described later. When the conveying device 900 does not convey any item 5, the conveying path 906 may be stopped. Then, when an item 5 ordered by a user is prepared to be served to a target seat, a staff or the like may place the item 5 on the conveying path 906 and press the delivery start button 900a to start delivering the item 5. When delivery of the item 5 starts, the item 5 is delivered toward its destination, and when the item 5 reaches the destination, the delivery automatically stops. This allows the user to reach out to the item 5 stopped on the conveying path 906 from the seat which is the target seat and take the item 5.

In this embodiment, it is desirable for the conveying device 900 to provide the items 5 etc. quickly, and the conveying speed of the conveying path 906 is set higher than the conveying speed of the conveying path 926. For example, the conveying device 900 may provide items 5 and the like mainly in response to the users placing the orders for the items 5 at each seat, as described below. On the other hand, the lower conveying device 920 provides the items 5 and the like regardless of orders from users. This allows, for example, a user to take an item 5 at any time when the item 5 is conveyed by the lower conveying device 920 to pass through the seat. In contrast, if a user has a desired item 5, the user can place an order and take the item 5 that is dedicatedly delivered by the conveying device 900 to the user.

Here, the restaurant system 1 uses detection devices 301. In this embodiment, each of the detection devices 301 is, for example, a camera (hereinafter, sometimes referred to as a camera 301). Each of the cameras 301 is arranged, for example, at a respective one of the seats and is configured to capture images (which may be still images or a video) in a range covering a particular detection area Z defined for the corresponding seat.

As shown in FIG. 1, in this embodiment, the adjacent seats are separated by a partition 985 having a certain height, and the camera 301 is disposed to have an imaging range covering a space for one seat defined between the partitions 985.

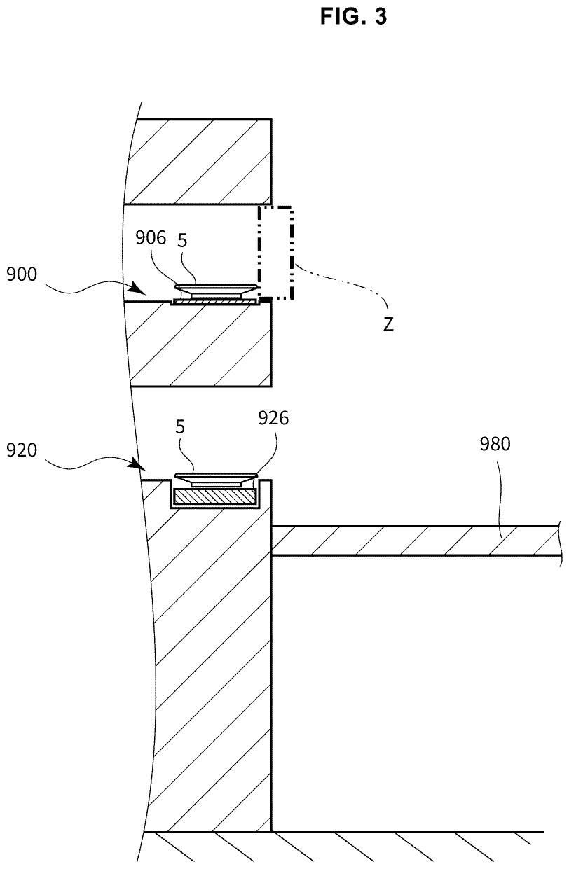

FIG. 3 is a side cross-sectional view showing the detection area Z in the restaurant system 1.

FIG. 3 shows a cross-section of a seat viewed in the conveying direction of the conveying device 900. In this embodiment, the detection area Z is an area located at a position laterally offset from the conveying path 906 when viewed in the conveying direction of the conveying path 906. Here, the “side” may be one side of the seat on which the user is positioned. The detection area Z is an area where a part of the user's body, such as a hand or arm, enters when the user using the seat reaches out toward the conveying path 906. The part of the user's body reaching out to the conveying path 906 passes through or is within the detection area Z of the seat. “Reaching out to the conveying path 906” refers to a state in which, for example, a user picks up an object from the conveying path 906 or places an object on the conveying path 906.

In this embodiment, an upper structure is provided on the top of the conveying device 900, on which the notification device 700 is disposed. In the vertical direction, the detection area Z is defined between the conveying device 900 and the upper structure. The vertical position and size of the detection region Z are not necessarily limited to this.

As shown in FIG. 2, in this embodiment, the detection area Z is set near the conveying path 906 for each seat.

In this embodiment, the camera 301 faces in a direction aligned with the conveying direction of the conveying device 900, and is disposed so that the detection area Z is included within the angle of view. The camera 301 is positioned to capture an image of a part of a user's body entering or passing through the detection area Z when the user reaches out his/her hand to the conveyance path 906.

However, the arrangement of the cameras 301 is not necessarily limited to this. For example, the camera 301 may be set to capture an image in a downward direction from the ceiling so that an area including the detection area Z can be captured by the camera 301.

FIG. 4 is a block diagram of the restaurant system 1.

As shown in the figure, the information processing device 100 includes a storage unit 110, a receiving unit 120, a reception unit 130, a processing unit 140, and a transmission unit 170.

The storage unit 110 includes an item information storage unit 111 and a user information storage unit 115.

The storage unit 110 may be preferably a non-volatile storage medium, but may also be a volatile storage medium. A plurality of pieces of information acquired by each device and the like are stored in the storages 112,115, but the process of storing information and the like is not necessarily limited to this. For example, information or the like may be stored via a storage medium, information transmitted via a communication line or the like may be stored, or information input via an input device may be stored.

The item information storage unit 111 stores, for example, item information on items 5 that can be served in the restaurant. In other words, the item information may be information on the menu. For example, the item information of each item 5 is stored in association with an item identifier to identify the item 5. The item information may include information such as a name of the item 5, unit price, an item group, and a price of the item 5. However, the item information may also include other information, or may not include some or all of the above information.

The user information storage unit 115 stores user information related to a user who uses the restaurant system 1. In the present embodiment, the user information is information in which a user identifier, which is an identifier for identifying a user who uses the restaurant system 1, is associated with information related to the user. The user information may include various information. For example, the user information is stored in the user information storage unit 115 by being received by the receiving unit 120, by being received by the reception unit 130, or by being acquired as a result of information processing executed by the processing unit 140.

In the present embodiment, the user information may be information related to a seat for the user. That is, in the present embodiment, the user information based on information transmitted from a terminal operable by the user, such as the notification device 700, may be stored in association with seat specifying information such as a seat identifier for specifying a seat and a terminal identifier for identifying the terminal device 600. In addition, the user information may include a predetermined attribute value related to a state in which the user visited the restaurant. The predetermined attribute value may be, for example, information such as the number of people in the customer group who are users, the time of visit (may be the elapsed time since the customer group visited the restaurant), etc., but is not necessarily limited thereto. Information such as the number of adults and children in the customer group may be also included. Further, an identifier or the like may be included for identifying a restaurant staff in charge of various serving operations for the seat used by the user.

Further, the user information may include, for example, information on the order history of the items 5. For example, order information indicating an ordering status for each seat and consumption information indicating a consumption status of the items 5 for each seat may be included as the user information.

The order information is, for example, information related to the orders of items, and information including seat specifying information for specifying the seat. The order information includes, for example, an item identifier and the number of orders. The order information may include, for example, the item identifier and a price. The order information may be, for example, information indicating that a plate on which the item 5 is placed was served (provided) to the customer group. In other words, the order information may include information subsequent to the order.

The consumption information is information related to the amount or quantity of the items 5 consumed by the user. In the present embodiment, the consumption information is, for example, the price of the item 5 consumed by the user, but is not necessarily limited thereto. The number of items 5 consumed by the user may be used as the consumption information. In the present embodiment, the item 5 is placed on a plate each predetermined unit and served to the user. In this case, the number of plates of the items 5 consumed by the user may be used as the consumption information.

In addition, as information related to the order history such as the order information and the consumption information, information related to the order history at the user's current eating occasion (i.e., the order history at this time) may be included in the user information. Based on such information on the order history, the user can be charged for the use of the restaurant. Such information on the order history may be stored, for example, for each user belonging to a customer group.

The receiving unit 120 receives information transmitted from other devices. The receiving unit 120 may be wireless or wired communication means, but may be means of receiving a broadcast.

The receiving unit 120 stores the received information in the storage unit 110, for example. In the present embodiment, the user can input information using the notification device 700 or the terminal device 600 and transmit the information to the information processing device 100, for example. The receiving unit 120 stores each transmitted information in the storage unit 110 by associating the information with the terminal identifier or the seat identifier. In the present embodiment, the receiving unit 120 receives order information transmitted from each terminal device 600 and the notification device 700, associates the information with the terminal identifier or the seat identifier, and stores the information in the storage unit 110. When receiving information from the notification device 700, the receiving unit 120 specifies, based on the transmitted information, the seat identifier for identifying a seat corresponding to the notification device 700. Further, when the receiving unit 120 receives information from the terminal device 600, the receiving unit 120 specifies the terminal identifier based on the transmitted information.

The reception unit 130 accepts information input via input means (not illustrated) connected to the information processing device 100. The reception unit 130 stores the received information in the storage unit 110, for example. The input means may be anything, such as a numeric keypad, a keyboard, a mouse, or a menu screen. The reception unit 130 may be a device driver for input means such as a numeric keypad or a keyboard, control software for a menu screen, or the like. The reception unit 130 may receive information input by an input operation using a reading device (for example, a code reader, etc.) connected to the information processing device 100. The information may include, e.g., information read by the reading device.

In other words, the reception unit 130 accepts the information received by the receiving unit 120 as information input into the information processing device 100. That is, the input of information into the information processing device 100 may be interpreted that this information is indirectly input into the information processing device 100 by the user via the notification device 700, the terminal device 600, or the like.

Note that the receiving unit 120 and the reception unit 130 may also receive and accept information transmitted or input by a restaurant staff.

The processing unit 140 performs various processes. Various processes include, for example, processes performed by each portion of the processing unit 140 as described below. The processing unit 140 may include a processor, a memory, or the like. The processing by the processing unit 140 is usually realized by software (computer program code), and the software is stored on a storage medium such as ROM. However, some or all of the processing may be realized by hardware (dedicated circuitry).

Herein, in this disclosure, the term “processor” refers to one or more hardware processors configured to execute program code (i.e., one or more instructions of a program) in a program. In other words, a “processor” is a hardware device that is capable of executing one or more programmed processes. For example, a “processor” may be a general-purpose or special-purpose processor, such as, but not limited to, a CPU, a microprocessor, a GPU, and a data flow processor (DFP).

In this disclosure, the term “memory” refers to one or more hardware memories that are non-transitory tangible storage media configured to store computer program code and/or data accessible to a processor. “Memory” may be implemented with memory technologies such as SRAM, SDRAM, non-volatile/flash type memory, or other types of memory. The computer program code constituting the program is stored on a memory and executed by a processor to cause the processing unit 140 to realize various functions.

The processing unit 140 is also configured to control the operation of the conveyance control unit 902. The conveyance control unit 902 is configured to control the conveying path 906 based on the control by the processing unit 140, which will be described later.

In this embodiment, the processing unit 140 is configured to output caution information indicating that an abnormality may have occurred in an item 5 upon determining that a predetermined caution condition is satisfied based on the detection result that a foreign object approaches the conveying path 906. Such a caution information output function is realized by a user information acquisition unit 141, a conveyance information acquisition unit 143, an image determination unit 153, a determination unit 161, a delivery notification unit 163, and a warning unit 165 included in the processing unit 140. Further, the processing unit 140 has a billing unit 165. Each component of the processing unit 140 may perform the following processing.

The user information acquisition unit 141 acquires user information that is information on a user who uses the restaurant, that is, a target user. For example, when outputting the alert information described later and charging, etc., the user information acquisition unit 141 acquires user information corresponding to an identifier for identifying the target user or seat from the user information storage unit 115. By acquiring the user information, it is possible to specify the terminal device 600 or the notification device 700 corresponding to the user or the seat.

An example of the user information used in the present embodiment is as follows.

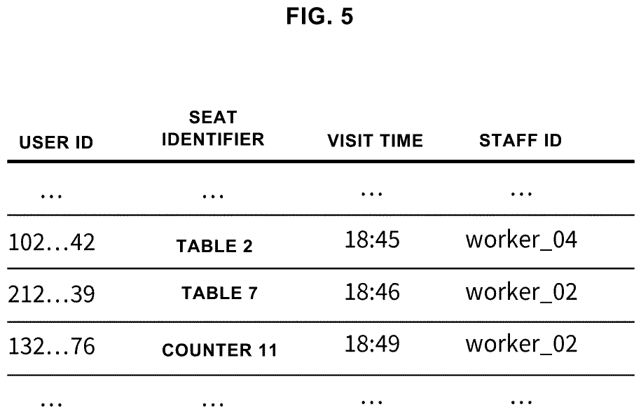

FIG. 5 is a diagram illustrating an example of the user information used by the information processing device 100.

In the example shown in the figure, as the user information, for example, attribute values such as the seat specifying information, a visit time, a staff in charge of serving for the seat used by the user, and the like are stored in association with a user identifier (user ID) for specifying the user information. For example, the seat identification information may include a seat identifier such as a table number from which the table 980 used by the user can be identified and a seat number from which the seat 981 of the user using the counter table 980b can be identified.

When the user information includes an identifier related to a staff in charge for the seat, the user or the staff for the seat may be specified based on the user information on each user.

Note that the user information may include information other than the above-described information, or any information (for example, a staff identifier, etc.) may be stored as information different from the user information. That is, the information stored in the storage unit 110 or the like that can be associated with the user identifier or the seat identifier, or information that can be acquired in association with the user identifier or the seat identifier, may be recognized as the user information.

The conveyance information acquisition unit 143 acquires the conveyance information related to an operating state of the conveying device 900. The conveyance information on the operating status of the conveying device 900 is, for example, information indicating whether a particular conveying device 900 is in operation to convey an item 5. Furthermore, the conveyance information may be information indicating where the item 5 is being conveyed to when the conveying device 900 is in operation, or information on the item 5 that is being conveyed. In this case, the information indicating which seat the item 5 is conveyed to may include, for example, the seat identifier. Furthermore, the information regarding the item 5 being conveyed may include, for example, an item identifier.

The conveyance information may be, for example, information indicating a control state of the conveyance control unit 902 that drives the conveying device 900. The conveyance information can be obtained, for example, using information indicative of the contents of an instruction given to the conveying device 900, but is not necessarily limited to this. For example, the conveying device 900 may be configured to output information indicating the control state of the conveyance control unit 902, and the conveyance information may be acquired based on that information.

The image determination unit 153 determines whether the caution state has occurred based on the image captured by the camera 301. In this embodiment, the caution state is a state in which a foreign object is approaching the conveying path 906. The foreign object may be, for example, a part of the user's body such as a hand, arm, or head, or an object held by the user (for example, a chopstick or a plate), but is not necessarily limited to these. The camera 301 at each seat captures images for that seat. Therefore, in this embodiment, it may be described that the image determination unit 153 determines whether the caution state has occurred at each seat. The caution state may also be called as an alert state.

The image determination unit 153 is configured to detect, for example, that a foreign object has entered the detection area Z and determine that the caution state has occurred. The image determination unit 153 may detect a foreign object using, for example, a differential image method, or may detect the presence of the foreign object in the detection area Z using a technique such as machine learning.

In this embodiment, the image determination unit 153 may constitute the detection unit 150 together with the camera 301 at each seat. The detection unit 150 may be described as follows. That is, the detection unit 150 is configured to detect the occurrence of the caution state in which a foreign object is approaching the conveying path 906 at each of the seats. The detection unit 150 is capable of detecting the occurrence of the caution state based on an image captured by the camera 301.

The determination unit 161 determines whether the predetermined caution condition is satisfied based on the conveyance information and the detection result by the detection unit 150. That is, in the present embodiment, the determination unit 161 determines whether the predetermined caution condition is satisfied based on the conveyance information and the determination result of the image determination unit 153. It may be said that the processing unit 140 determines whether the predetermined caution condition is satisfied based on the conveyance information and the images captured by the camera 301. The caution condition may be referred to as an alert condition.

The predetermined caution condition may include a condition regarding the operating state of the conveying device 900 and a condition whether the caution state has occurred. In the present embodiment, determination regarding the caution condition is performed for each seat. That is, the determination unit 161 is configured to determine that, when the caution state occurs for one seat, the caution condition is satisfied for that seat. In this case, the determination unit 161 may be configured to output the seat identifier in response to determining that the caution condition is satisfied. Note that the determination unit 161 may determine whether the caution condition is satisfied for each of two or more seats (for example, for each block when the restaurant is divided into a plurality of blocks each having certain number of seats) or may determine whether the caution condition is satisfied irrelevant to the seats. For example, the determination unit 161 may simply determine that the caution condition is satisfied without identifying the seat at which the condition is satisfied.

More specifically, the caution condition may be described as follows:

For example, the caution condition may be a condition in which the item 5 is being conveyed by the conveying device 900 and a foreign object has entered the detection area Z for the corresponding seat that is not the destination seat (the target seat) for the item. In this case, the caution condition may include a condition where the caution state is detected at any of the seats upstream of the target seat in the conveying direction of the conveying device 900 when the item 5 is conveyed. If the caution state occurs on an upstream side of the destination seat, there is a possibility that an abnormality will occur with the item 5, such as the item 5 coming into contact with the foreign object that approached the conveying path 906. In such a case, the caution condition may be determined to be satisfied. On the other hand, if a foreign object approaches the conveyance path 906 at a position downstream of the target seat, the foreign object will not affect the items 5 for the user of the target seat. In addition, at the target seat, there is a possibility that a user may approach the conveying path 906 to immediately take the delivered item 5, and in this case, it may not be necessary to treat his/her action as the caution condition being satisfied. In such a case, the caution condition is not determined to be satisfied.

For example, the caution condition may be a condition in which the item 5 is being conveyed by the conveying device 900 and a foreign object has entered the detection area Z for the corresponding seat that includes the destination seat (the target seat) for the item. Since there is a possibility that a user may come into contact with the item 5 during conveyance at the destination seat, it may be determined that the caution condition is met.

Also, for example, the caution condition may include a condition in which the item 5 is being conveyed by the conveying device 900, and the caution state is detected at any seat upstream of the target seat after the delivery notification was output by the delivery notification unit 163 as described below. In this case, the caution condition can be reliably determined to be met when there is a relatively high possibility that an abnormality occurred in the item 5 that is being conveyed, such as when a user who has learned that the item 5 was being conveyed from the delivery notification causes the caution state.

Also, for example, the caution condition may be a condition that the caution state is detected at any seat when the conveying device 900 is not in operation. If the conveying device 900 starts operating with a foreign object on the conveying path 906 when conveyance is not performed, an unexpected problem may occur. When there is a possibility that such a trouble may occur, the caution condition may be determined to be met.

The caution condition may be a combination of the above-described conditions. For example, when the conveying device 900 is not conveying the item 5, the caution condition may be determined to be satisfied if the occurrence of the caution state is detected at any of the seats. On the other hand, when the conveying device 900 is conveying the item 5, the caution condition may be determined to be satisfied only if the occurrence of the caution state is detected at any of the seats upstream of the destination seat.

The caution condition is not necessarily limited to the above-mentioned conditions, and other conditions may be used or may include other conditions. For example, the caution condition may be a condition that the caution state is detected at any seat when the conveying device 900 conveys the item 5. For example, a condition related to the number of users, the time of day, the degree of congestion of the restaurant, the number of staffs, the type of the item 5 that is conveyed, and the like may be used. The condition regarding the type of item 5 that is conveyed may be, for example, a condition regarding the item belonging to a specific category (e.g., sushi, dessert, side dish, etc.) or the item being provided in a specific form (e.g., housed in a specific container or packaged). In this case, the caution condition may be determined to be satisfied when this condition, a condition regarding the operating state of the conveying device 900, and a condition regarding whether the caution state has occurred are all satisfied.

The delivery notification unit 163 outputs, in a manner corresponding to the destination seat, a delivery notification indicating that the item 5 will be delivered to the target seat presently by the conveyance device 900. The delivery notification may be output when a staff places an item 5 on the conveying path 906 and presses the delivery start button 900a. That is, the delivery notification unit 163 receives an operation signal from the delivery start button 900a. Then, when the operation signal of the delivery start button 900a is received, the delivery notification unit 163 may output the delivery notification. As another embodiment, for example, as shown in FIG. 2, an item sensor 900b may be disposed in the conveying device 900 near the boundary between the kitchen 1b and the dining area 1a of the restaurant. The item sensor 900b is configured to detect the item 5 conveyed from the kitchen 1b to the dining area 1a, and outputs a detection signal to the delivery notification unit 163. Then, when the detection signal is input from the item sensor 900b, the delivery notification unit 163 may output the delivery notification. As the item sensor 900b, for example, an optical sensor, a photoelectric sensor, a camera, or the like may be used.

As another embodiment, a weight sensor 900c may be provided on the conveying path 906 of the conveying device 900. The weight sensor 900c is provided, for example, on the back side of the conveying path 906 and is configured to detect an item 5 when the item 5 is placed on the conveying path 906. The weight sensor 900c is configured to output a detection signal of the item 5 to the delivery notification section 163. Then, when the detection signal of the item 5 is input from the weight sensor 900c, the delivery notification unit 163 may output the delivery notification.

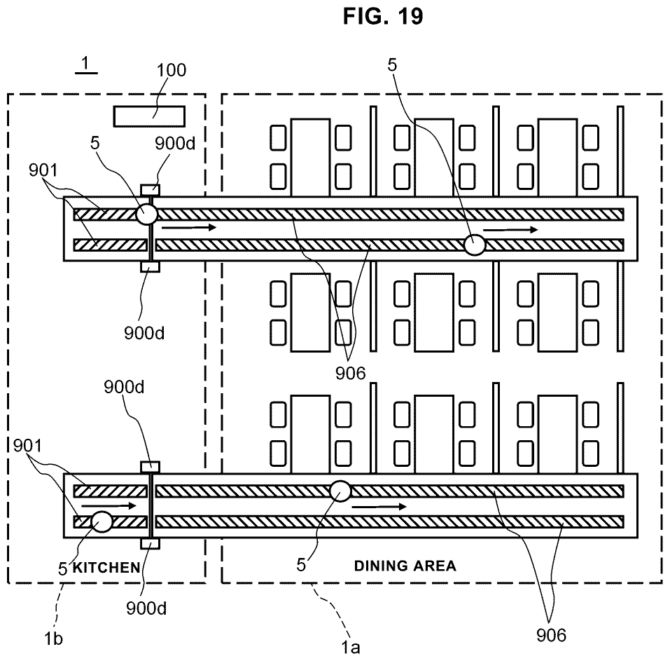

FIG. 19 is a plan view of the restaurant showing a conveying device 900 according to another embodiment. The conveying device 900 shown in FIG. 19 includes a transfer conveying path 901 provided in the kitchen 1b. The transfer conveying path 901 is continuously connected to a start edge portion of the conveying path 906. The transfer conveying path 901 functions to convey the item 5 towards the start edge portion of the conveying path 906 to transfer the item 5 to the conveying path 906. That is, when a staff prepares an item 5 and places the item 5 on the transfer conveying path 901, the item 5 is automatically transferred to the conveying path 906. The conveying device 900 includes an item sensor 900d that detects an item 5 being transferred from the transfer conveying path 901 to the conveying path 906. In the example shown in FIG. 19, the item sensor 900d is disposed at a boundary portion between the transfer conveying path 901 and the conveying path 906, but the location of the item sensor 900d is not necessarily limited to this position. The item sensor 900d may be disposed anywhere as long as the item sensor 900d can detect the item 5 being transferred from the transfer conveying path 901 to the conveying path 906. When the item sensor 900d detects an item 5, the item sensor 900d outputs a detection signal to the delivery notification section 163. Then, when the detection signal is input from the item sensor 900d, the delivery notification unit 163 may output the delivery notification. As the item sensor 900d, for example, an optical sensor, a photoelectric sensor, a camera, or the like may be used.

Here, “outputting the delivery notification in a manner corresponding to the destination seat” means, for example, outputting the delivery notification so that notification is performed by the notification device 700 at the target seat or notification is made by the notification device 700 at the target seat and other seats upstream of the target seat. If the terminal device 600 is disposed to a seat to be notified, the delivery notification may be output so that the notification is performed by the terminal device 600.

When the determination unit 161 determines that the predetermined caution condition is satisfied, the warning unit 165 outputs caution information for alerting a user that an abnormality may have occurred in the item 5 that is being conveyed on the conveying path 906. The caution information may be information indicating that an abnormality related to the item 5 may have occurred. In other words, when the predetermined caution condition is satisfied based on the conveyance information and the images captured by the camera 301, the warning unit 165 outputs the caution information indicating that an abnormality related to the item 5 may have occurred. Note that the caution information may be referred to as alert information.

Output of the caution information may include, for example, transmitting information for displaying, by another device, an image that an abnormality related to an item 5 may have occurred, outputting information to a display unit or the like in the information processing device 100, and outputting information including an instruction for controlling another device to execute a predetermined operation.

In this embodiment, the warning unit 165 is configured to output the caution information in an output manner corresponding to a seat when the determination unit 161 determines that the caution condition is satisfied for that seat. In other words, when the detection unit 150 detects that the caution state has occurred at a seat and the determination unit 161 determines that the caution condition is satisfied, the warning unit 165 outputs the caution information in an output manner corresponding to the seat for which the detection unit 150 detected the caution state.

“Outputting the caution information in an output manner corresponding to a seat” may include, for example, outputting the caution information having the content displayed according to the caution information correspond to the seat identifier of that seat, outputting the caution information using information that can be acquired based on the seat identifier, and outputting the alert information in both the above-outputting ways. “Having the display content correspond to the seat identifier” may include, for example, having the display content include information on the seat for which the caution state has occurred. For example, information for identifying the seat, such as “The caution state might occur at the seat No. XX”, may be displayed. In addition, “outputting using information that can be acquired based on the seat identifier” may include, for example, outputting the information so that displaying an image based on the caution information is performed by the notification device 700 identified by the seat identifier or outputting the information so that displaying an image based on the caution information is performed by the terminal device 600 identified by the seat identifier. The caution information may be output to the terminal device 600 or the like used by the staff in charge of that seat.

In this way, based on the caution information, the information processing device 100 or another device can display or output information for identifying the seat to which the caution information is output due to the caution state occurring at the seat, information indicating that there may be an abnormality on the item 5, information indicating that there may be an abnormality on the item 5 currently being conveyed within the area assigning to a particular staff, or information indicating that there may be an abnormality at a particular table.

Furthermore, when the determination unit 161 determines that the predetermined caution condition is satisfied during delivery of the item 5, the warning unit 165 may output the caution information in an output manner corresponding to the target seat to which the item 5 is delivered. In this case, similarly to the above, the caution information may be output in an output manner corresponding to the target seat. For example, information informing the user at the target seat that there may be an abnormality on the item 5, such as “Please do not take the item that has just been delivered and wait for a while.”, may be displayed, based on the caution information, on the terminal device 600 or the notification device 700 disposed at the destination seat. In addition, information, such as “There may be an abnormality in the item for the table No. XX.”, from which the item 5 or the seat that may be affected by the caution state can be identified may be displayed on the terminal device 600 or the notification device 700 for staffs or the kitchen.

In this way, the caution information can be transmitted to the notification device 700 or the terminal device 600 associated with the seat to which the item 5 is delivered now or will be delivered in the future and the caution information is output to that seat, or the caution information can be transmitted to the notification device 700 in the kitchen corresponding to the item 5 and the caution information is output at the kitchen. Further, the caution information may be output by transmitting the caution information to the notification device 700 or the terminal device 600 that is related to the seat which is a trigger that the caution condition was determined to be met. In this case, the warning unit 165 may output, as the caution information, information including a content (e.g., messages) reproving a user for his/her act causing such an abnormality as information indicating that an abnormality related to the item 5 may have occurred.

Further, outputting the caution information may include storing occurrence information regarding the fact that the caution condition was met in the storage unit 110 or the like. The occurrence information may be, for example, information such as the fact that the caution condition was met, the determination time of the alert condition, and the like, but is not necessarily limited thereto. In this case, information may be stored in a manner corresponding to, for example, (i) the seat where the detection unit 150 detected that the caution state has occurred, (ii) the user using that seat, or (iii) the seat to which the item 5 is to be delivered. For example, the seat identifier and the occurrence information may be stored in association with each other, or the user identifier corresponding to the seat and the occurrence information may be stored in association with each other.

The billing unit 167 charges the user corresponding to the seat where the caution state was detected based on the detection result of the detection unit 150, for example. For example, when a predetermined charging condition is determined to be met from the detection result of the detection unit 150, the billing unit 167 can charge the user at the corresponding seat. The determination may be performed, for example, by the determination unit 161.

The charging condition may include, for example, a normal charging condition in which charging is made in compensation for the item 5. When the normal charging condition is met, the billing unit 167 charges the seat user for the price of the item 5.

The charging condition may include a special charging condition in which charging is made for an amount not in compensation for the item 5. If the special billing condition is met, the billing unit 167 may charge, for example, a predetermined amount to the user of the seat where the caution state was detected. The special charging condition may be, for example, the same as the caution conditions, or one of the caution conditions may be set as the special charging condition.

By making charging based on such a special charging condition, it is possible to effectively avoid a situation where a user or the like causes an abnormality.

The transmission unit 170 transmits information to another device via a network or the like. The transmission unit 170 transmits information to, for example, the notification device 700 and the terminal device 600. In other words, the transmission unit 170 outputs information to, for example, the notification device 700 and the terminal device 600.

Note that the transmission unit 170 may be wireless or wired communication means, but may also be broadcasting means.

In the present embodiment, when the warning unit 165 outputs the caution information, the transmission unit 170 transmits the caution information, for example, to the notification device 700 or the terminal device 600 used by the user at the corresponding seat or to the notification device 700 or terminal device 600 used by staffs. Then, the notification device 700 or the terminal device 600 displays an image based on the caution information on the notification display 761 or the terminal display 661. Thereby, the user, the staff, and the like recognize the image based on the caution information and take necessary steps.

In this embodiment, the processing unit 140 is configured to control the conveyance control unit 902 to stop delivery of the item 5 when the determination unit 161 determines that the caution condition is satisfied while the item 5 is being conveyed by the conveying device 900. In other words, the conveyance control unit 902 is configured to stop delivery of the item 5 when the determination unit 161 determines that the predetermined caution condition is satisfied during the delivery of the item 5. In this way, if the caution condition is determined to be met, the delivery of the item 5 is stopped so that the item 5 on which an abnormality may have occurred is prevented from being delivered to the target seat. However, such control does not have to be performed.

In the present embodiment, the information processing device 100 provides, together with the conveying device 900, a caution function by, for example, performing various operations as follows. These operations are performed by the processing unit 140 executing control operations or the like using each of the units.

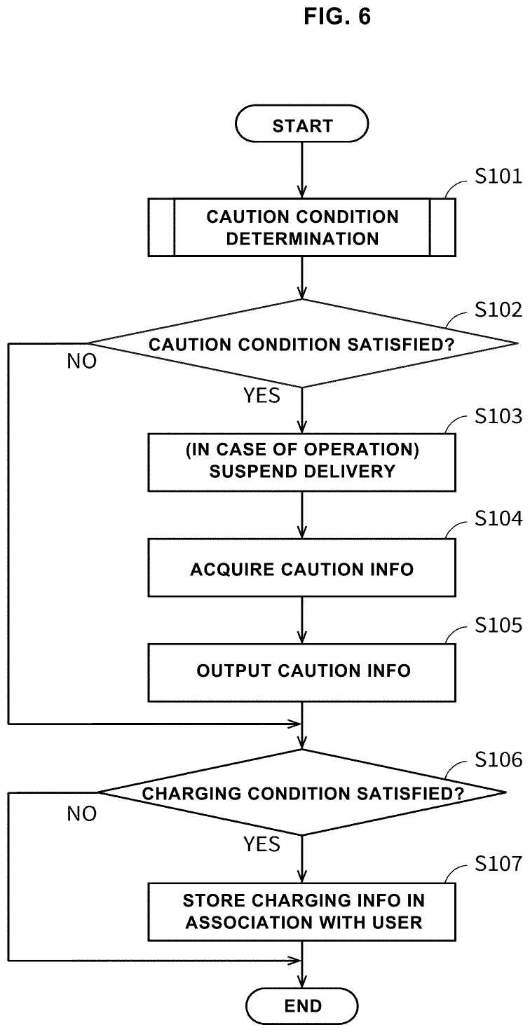

FIG. 6 is a flowchart illustrating one example of the operation by the information processing device 100.

The process shown in the figure is performed, for example, periodically. However, the process may be performed when other predetermined execution conditions are met (for example, a predetermined timing has come, a predetermined information has been detected), or the like.

(Step S101) The processing unit 140 performs a caution condition determination process. The caution condition determination process will be described later.

(Step S102) The processing unit 140 determines whether the caution condition is satisfied (the caution condition is satisfied). The determination can be made based on, for example, the presence or absence of a flag or contents of the flag, for example, stored in the storage unit 110. It should be noted that if the determination is made based on the existence of the flag, the flag is subsequently cleared. If the caution condition is determined to be met, the process proceeds to step S103, and if not, the process proceeds to step S106.

(Step S103) The processing unit 140 stops operation of the conveying path 906 of the conveying device 900. The processing unit 140 stops the delivery by, for example, outputting an instruction to the conveyance control unit 902 of the conveyance device 900, but is not necessarily limited to this. This process does not have to be performed if delivery by the conveying path 906 is not performed.

(Step S104) If the caution condition is satisfied, the processing unit 140 acquires the caution information. The caution information may be formed, for example, according to the seat identifier of the seat where the caution condition has occurred, as described above.

(Step S105) The processing unit 140 outputs the acquired caution information. The caution information may be output to an output destination specified by the seat identifier that identifies the seat where the caution state occurred or the target seat, as described above, for example.

(Step S106) Next, the processing unit 140 determines whether the billing condition is satisfied at any seat or user. The determination is made, for example, according to the presence or absence of the flag stored in the storage unit 110 or the contents, and if the determination is made based on the presence of the flag, the flag is then cleared. If the billing condition is satisfied, the process proceeds to step S107. If not, the caution condition is satisfied.

(Step S107) The processing unit 140 makes a charge according to the determination that the charging condition is met. For example, charging may be made by storing charging information including information specifying an amount, the item 5, and the like in association with the seat or the user in the user information storage unit 115. However, the charging method is not necessarily limited to this, and various methods may be used. After that, the series of processes are terminated.

In the above description, the processes in steps S103, S106, and S107 may not be necessarily performed. In the case where the process of step S106 is not performed, the caution condition is determined to be satisfied at step S102, the series of processes may be terminated.

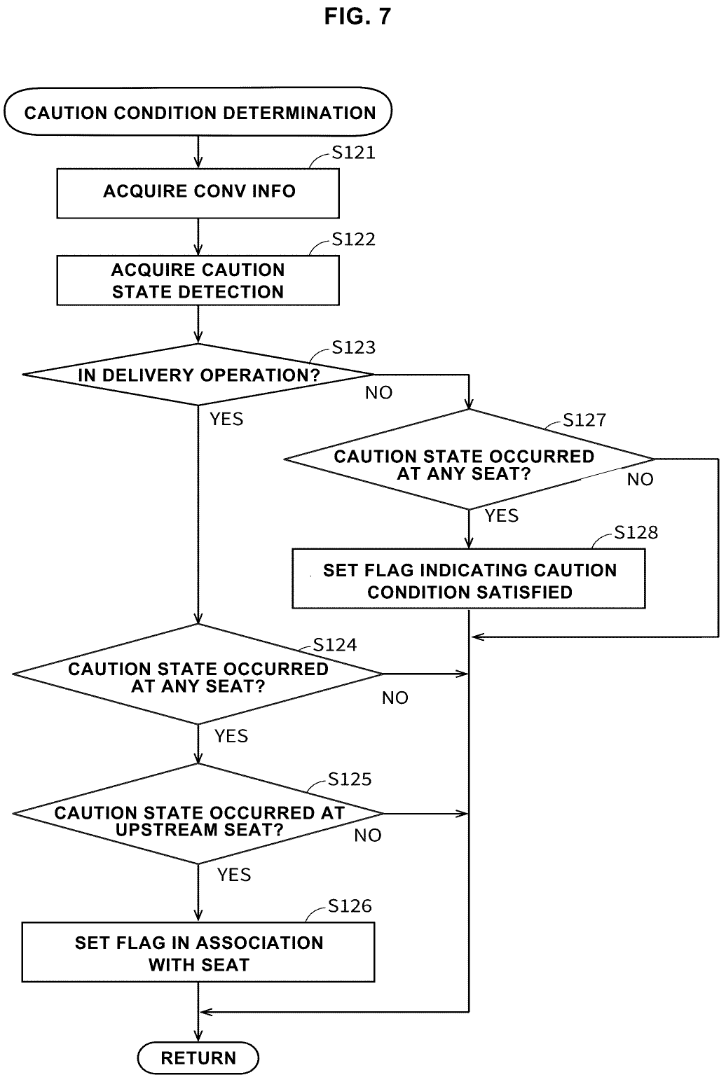

FIG. 7 is a flowchart of one example of the caution condition determination process performed by the information processing device 100.

(Step S121) The processing unit 140 acquires the conveyance information regarding the conveying device 900. When a plurality of conveying devices 900 are used, the conveying information may be acquired for each of the conveying devices 900.

(Step S122) The processing unit 140 acquires a detection result as to whether the caution state has occurred. For example, when an occurrence of the caution state can be determined for each seat, the detection result may include information such as the seat identifier identifying the seat where the caution state has occurred, but is not necessarily limited to this.

(Step S123) The processing unit 140 determines whether the conveying device 900 is in operation based on the conveyance information. If the conveying device 900 is determined to be in operation, the process proceeds to step S124, and if not, the process proceeds to step S127. When a plurality of conveying devices 900 are used, the conveying device 900 that is determined to be in operation may be identified, but the present disclosure is not necessarily limited to this.

(Step S124) The processing unit 140 determines whether the caution state has occurred at any seat based on the detection result of the caution state. If the caution condition is determined to have occurred at any seat, the process proceeds to step S125, and if not, the caution condition determination process ends.

(Step S125) The processing unit 140 determines whether the seat for which the caution state was detected is a seat upstream of the target seat, i.e., whether the caution state occurred at a seat upstream of the target seat. If the seat for which the caution state was detected is a seat upstream of the target seat, the process proceeds to step S126, and if not, the caution condition determination process ends.

The processes at steps S124 and S125 may be considered as one process for determining whether the caution state has occurred in a seat upstream of the target seat. In addition, when a plurality of conveying devices 900 are used, at step S124, the processing unit 140 may determine whether the caution state has occurred at any seat as to the conveying device 900 that is determined to be in operation.

(Step S126) In this case, the processing unit 140 determines that the caution condition is satisfied, and stores, in the storage unit 110, a flag indicating that the caution condition is satisfied. Here, the flag or the like is stored in the storage unit 110 in association with the seat for which the caution state has been detected. For example, the flag or the like indicating that the caution condition is satisfied is stored in the storage unit 110 in association with the seat identifier of that seat. Thereafter, the caution condition determination process ends.

(Step S127) On the other hand, if an item is not being conveyed, the processing unit 140 determines whether the caution state has occurred at any seat based on the detection result of the caution state. If the caution condition is determined to have occurred at any seat, the process proceeds to step S128, and if not, the caution condition determination process ends.

(Step S128) In this case, it can be described that the processing unit 140 has determined that the caution condition is satisfied. The processing unit 140 stores, for example, a flag indicating that the caution condition is satisfied in the storage unit 110. Thereafter, the caution condition determination process ends.

In this way, the caution condition determination process is performed, and if the caution condition is determined to be satisfied, the caution information is acquired and output. In the present embodiment, when the caution information is output by the caution function, the notification device 700 or the like as the output destination may display, for example, the following notification screen and to perform a notification (alert) based on the caution information. In this example, it is assumed that information for displaying a caution screen is output as the caution information.

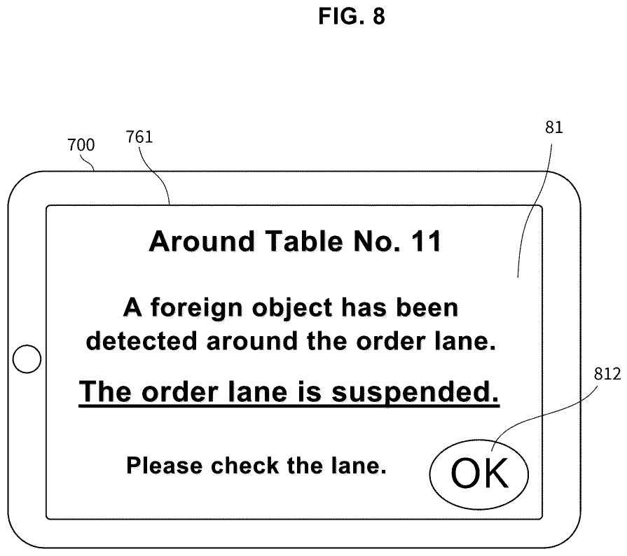

FIG. 8 is a diagram illustrating an example of a screen in which a notification based on the caution information is performed by the notification device 700.

As shown in the figure, in the present embodiment, when a notification based on the caution information is performed by the notification device 700, the caution screen 81 is displayed on the notification display 761 of the notification device 700. In the example shown in the figure, an example of the caution screen 81 displayed for staffs on the notification device 700 disposed in a backyard such as the kitchen is shown, for example. The caution screen 81 displays information indicating the seat for which the abnormality has occurred and information indicating that the caution state has been detected, such as, for example, “A foreign object has been detected near the table No. 11 around the order lane (the conveyor path 906).” In addition, in this embodiment, information regarding the fact that delivery by the conveying device 900 has been suspended is also displayed, such as “The order lane is suspended. Please check the lane.” to indicate that a staff or the like needs to check the conveying device 900. In the caution screen 81, a confirmation button 812 is included, and the screen is switched from the caution screen 81 to another screen by operating the confirmation button 812.

By outputting the caution screen 81, a staff or the like who has seen the caution screen 81 can easily recognize that an abnormality may have occurred and confirm the location (the seat). Since the output caution information causes a staff to notice information about the seat where the caution state was detected, it is possible for the staff to easily respond to the caution state.

As described above, in the present embodiment, an alerting method using the caution information output function can be performed in the restaurant system 1. The alerting method may include a conveyance information acquisition step of acquiring conveyance information regarding an operating status of the conveying device 900, a determination step of determining whether the caution condition is satisfied based on the conveyance information and the detection results by the detection unit 150, and an alerting step with the warning unit 165 outputting the caution information to alert the user that an abnormality may have occurred in the item 5 that is conveyed by the conveying path 906 when the predetermined caution condition is determined to be satisfied at the determination step.

This caution information output function outputs the caution information when there is a possibility that the caution state has occurred, thereby alerting users or staffs to the possibility that there may be an abnormality in the item 5 conveyed by the conveying path 906. In addition, by informing users that the caution information output function is operating in the restaurant, it is possible to have the effect of deterring users from performing actions that may cause the caution state.

In this embodiment, the entry of a foreign object in the detection area Z on one side of the conveying path 906 can be detected, and accordingly, attention can be drawn to the possibility that an abnormality has occurred on an item 5. When the caution condition is determined to be met during delivery of an item 5 by the conveying path 906, the delivery of the item 5 can be stopped, thereby preventing an actual abnormality from occurring on the item 5 that is being conveyed.

In this embodiment, the caution information is output in a manner corresponding to the seat for which the occurrence of the caution state was detected. Therefore, the caution information can be output appropriately according to the purpose for which the caution information is output, and the effect can be obtained. For example, when the caution information output function is used for staffs to recognize the situation of the seat for which the caution state was detected, the caution information may be output, according to the seat identifier, the notification device 700 in the kitchen or the terminal device 600 used by a staff or the caution information including information for easily identifying the seat for which the caution state was detected. Thus, it is easier to achieve the purpose.

In addition, when the caution information output function is used for the purpose of notifying a user that an item 5 in which an abnormality may have occurred is being conveyed, or for the purpose of notifying a user of the fact that the conveying device 900 is temporarily suspended because the caution condition is determined to be met, i.e., that the delivery of the item 5 has stopped, the caution information can be output to the notification device 700 etc. corresponding to the seat to which the item 5 is currently or will be delivered, depending on the seat or the target seat for which the caution state was detected, or the caution information may include information for identifying the item 5 related to the abnormality. Therefore, it is possible to limit targets to which notification needs to be given while still achieving the purpose.

In addition, for example, when the caution information is output for the purpose of informing a user that an item 5 on which an abnormality may have occurred is being conveyed, the caution condition determination process may be performed, for example, as follows.

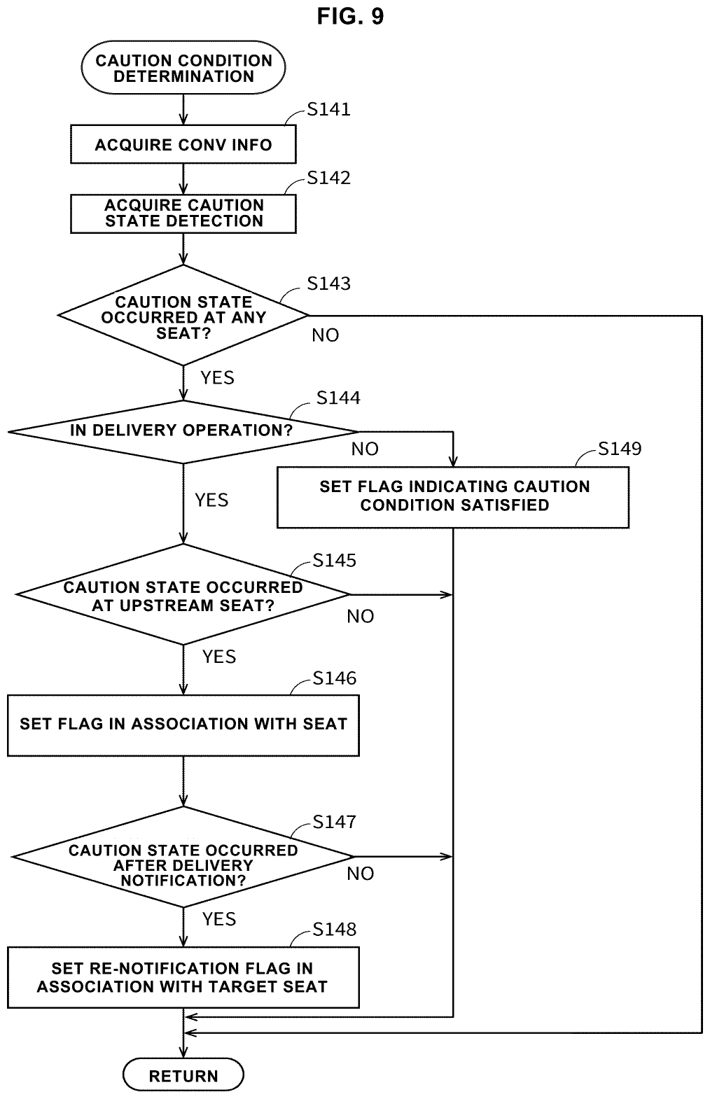

FIG. 9 is a flowchart of a modified example of a caution condition determination process performed by the information processing device 100.

The following modified example is substantially different from the above-described example in that the processing unit 140 determines whether the caution state has occurred after the delivery notification was output. Also, the order of the determination of whether the caution state has occurred and the determination of whether an item is being conveyed is different from that described above.

(Step S141) The processing unit 140 acquires the conveyance information regarding the conveying device 900. This is the same as step S121.

(Step S142) The processing unit 140 acquires a detection result as to whether the caution state has occurred. This is the same as step S122.

(Step S143) The processing unit 140 determines whether the caution state has occurred at any seat based on the detection result of the caution state. This is the same as step S124. If the caution condition is determined to have occurred at any seat, the process proceeds to step S144, and if not, the caution condition determination process ends.

(Step S144) The processing unit 140 determines whether the conveying device 900 is in operation based on the conveyance information. This is the same as step S123. If the conveying device 900 is determined to be in operation, the process proceeds to step S145, and if not, the process proceeds to step S149.

(Step S145) The processing unit 140 determines whether the seat for which the caution state was detected is a seat upstream of the target seat, i.e., whether the caution state occurred at a seat upstream of the target seat. If the seat for which the caution state was detected is a seat upstream of the target seat, the process proceeds to step S146, and if not, the caution condition determination process ends.

(Step S146) The processing unit 140 determines that the caution condition is satisfied, and stores, in the storage unit 110, a flag indicating that the caution condition is satisfied. Here, the flag or the like is stored in the storage unit 110 in association with the seat for which the caution state has been detected. For example, the flag or the like indicating that the caution condition is satisfied is stored in the storage unit 110 in association with the seat identifier of that seat.

(Step S147) Here, in this modified example, the processing unit 140 determines whether the caution state has been detected after the delivery notification was output by the delivery notification unit, i.e., whether the caution state has occurred after the output of the delivery notification. If the caution state is determined to have occurred after the delivery notification was output, the process proceeds to step S148; otherwise, the caution state determination process ends.

(Step S148) In this case, the processing unit 140 stores, for example, a re-notification flag in the storage unit 110 in association with the destination seat. The re-notification flag may be described as a flag indicating that the caution condition is satisfied when the delivery notification is made. Thereafter, the caution condition determination process ends.

When the re-notification flag is stored in this manner, the caution information to be output in association with the destination seat is acquired, and the caution information is output to the destination seat. This makes it possible to inform a user at the target seat that an abnormality may have occurred in the item 5 for which the delivery notification has been already made or that the item 5 for which the delivery notification has been made will not be delivered properly. Therefore, the user can know the status of the item 5 for which the delivery notification has been made.

In addition, the caution information output in response to the re-notification flag may be interpreted as one of the caution information output in response to a flag indicating that the caution condition is satisfied, or may be interpreted as information different from the caution information output in response to the flag indicating that the caution condition is satisfied.

(Step S149) On the contrary, when the conveying device 900 is not in operation, the processing unit 140 determines that the caution condition is satisfied, and stores, in the storage unit 110, a flag indicating that the caution condition is satisfied. Thereafter, the caution condition determination process ends.

In the flowchart of this modified example, the processes of steps S145, S146, and S149 may not be performed. This can be changed appropriately depending on the setting state of the caution condition. For example, if the caution state occurs at any seat during delivery after the delivery notification was output, the processing unit 140 may determine that the caution condition is satisfied and the re-notification flag may be stored.

In this modified example, when the caution information is output for the purpose of informing a user that an item 5 in which an abnormality may have occurred is being conveyed (when the caution information is output in accordance with the re-notification flag), the caution screen 82 based on the caution information may be, for example, as follows:

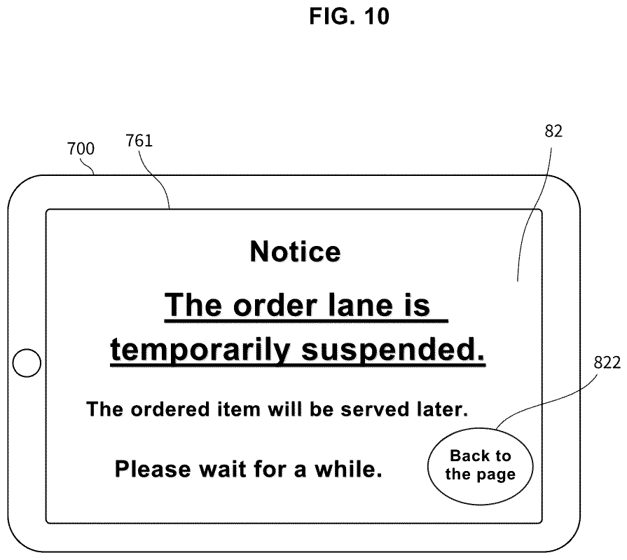

FIG. 10 is a diagram illustrating another example of a screen in which a notification based on the caution information is performed by the notification device 700.

Here, an example of the caution screen 82 based on the caution information is shown, which is displayed on the notification display 761 of the notification device 700 installed at the user's seat. The caution screen 82 displays information indicating that the item 5 is not delivered using the conveying device 900, such as “The order lane has been temporarily suspended.” In the caution screen 82, a confirmation button 822 is included, and the screen is switched from the caution screen 82 to a regular screen through which an order is placed by operating the confirmed button 812.

By outputting such the caution screen 82, a user or the like who sees the caution screen 82 can easily confirm that there may be an abnormality with the item 5 on the conveying path 906, and confirm the situation regarding the item 5, etc.

### Second Embodiment

A second embodiment will be described below with respect to the difference from the first embodiment. The second embodiment is different from the first embodiment in that a detection unit 250 different from the detection unit 150 of the first embodiment.

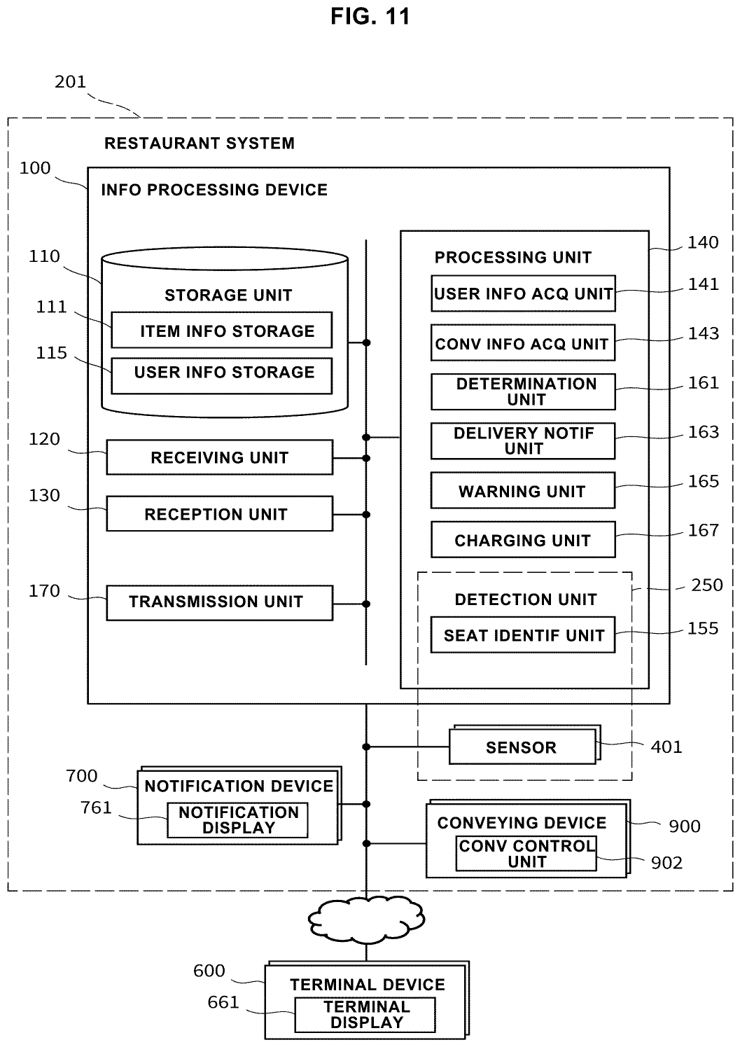

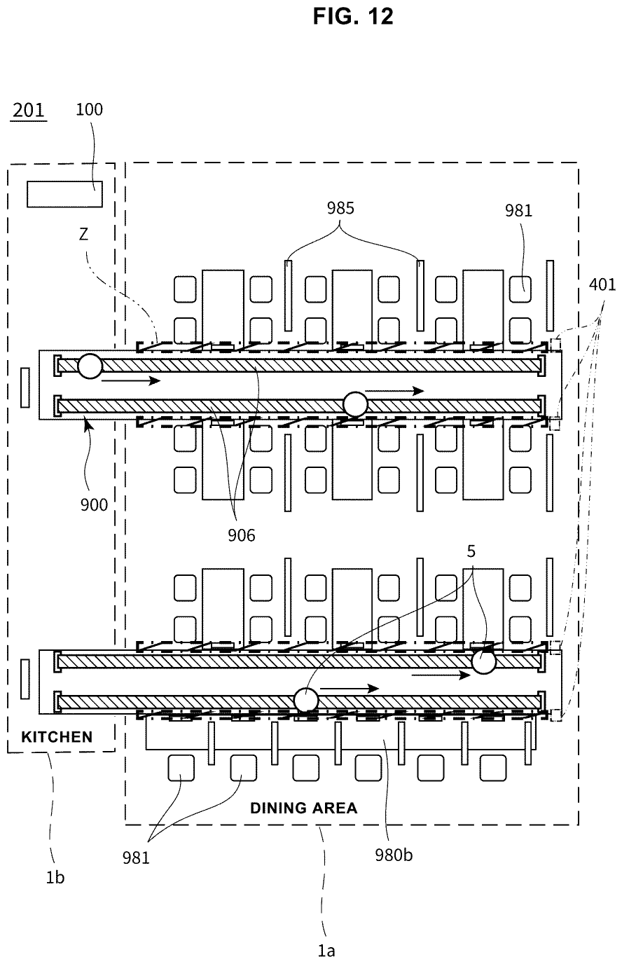

FIG. 11 is a block diagram of a restaurant system 201 according to the second embodiment. FIG. 12 is a plan view showing an overview of the restaurant system 201.

In the second embodiment, the restaurant system 201 has the detection unit 250 that uses a sensor 401 (one example of a detection device 401) instead of using the camera 301 disposed at each seat in the first embodiment as described above. The detection unit 250 may be formed of, for example, a seat identification unit 155 included in a processing unit 140 of an information processing device 100 and a sensor 401 disposed in the dining area 1a. The seat identification unit 155 is provided in place of the image determination unit 153 provided in the processing unit 140 described in the first embodiment.

The sensor 401 is, for example, a distance measuring sensor. In this embodiment, the sensor 401 is installed in association with a group including at least two seats. The sensor 401 is configured to detect the distance to a foreign object that has entered the detection area Z of each seat in the group.

The sensor 401 may be, for example, a sensor that emits a laser beam or light (infrared rays) from an LED or the like and detects the reflected light. Alternatively, the sensor 40 may be a so-called ultrasonic sensor. LiDAR or the like may also be used as the sensor 401.

As shown in FIG. 12, for example, it is assumed that in the dining area 1a, three seats are linearly arranged along the conveying direction (to the right in the figure) for each conveying path 906. In this case, one sensor 401 is disposed for the group of three seats so that the detection range of the sensor 401 cover the detection areas Z of the three seats on a side of the conveying path 906. When a foreign object enters the detection area Z at any seat, the sensor 401 can detect the distance to the foreign object and output the detected distance.

The seat identification unit 155 is configured to identify, based on the distance to the foreign object detected by the sensor 401, the seat among from the two or more seats included in the group corresponding to the sensor 401 for which the caution state has occurred.

For example, it is assumed that the three seats are arranged in a row as described above and one sensor 401 is used for the group of the three seats. In this case, when the sensor 401 detects the distance to a foreign object, the seat identification unit 155 determines whether the detected distance is within a distance range corresponding to the first seat, a distance range corresponding to the second seat, or a distance range corresponding to the third seat. Then, the seat where the detected distance is within the distance range is identified as a seat for which the caution state has occurred.

In this manner, the detection unit 250 is configured to detect the caution state when the seat for which the caution state has occurred is identified by the seat identification unit 155, and to output a seat identifier or the like that identifies the seat for which the caution state has occurred. The processing unit 140 can use the detection result of the detection unit 250 to determine whether the caution condition is satisfied or to output the caution information as with the first embodiment.

In the second embodiment, it is possible to detect the caution state at each seat while using sensors 401 whose number is less than the number of seats.

In the second embodiment, the sensors 401 may be provided for each of the two or more seats.

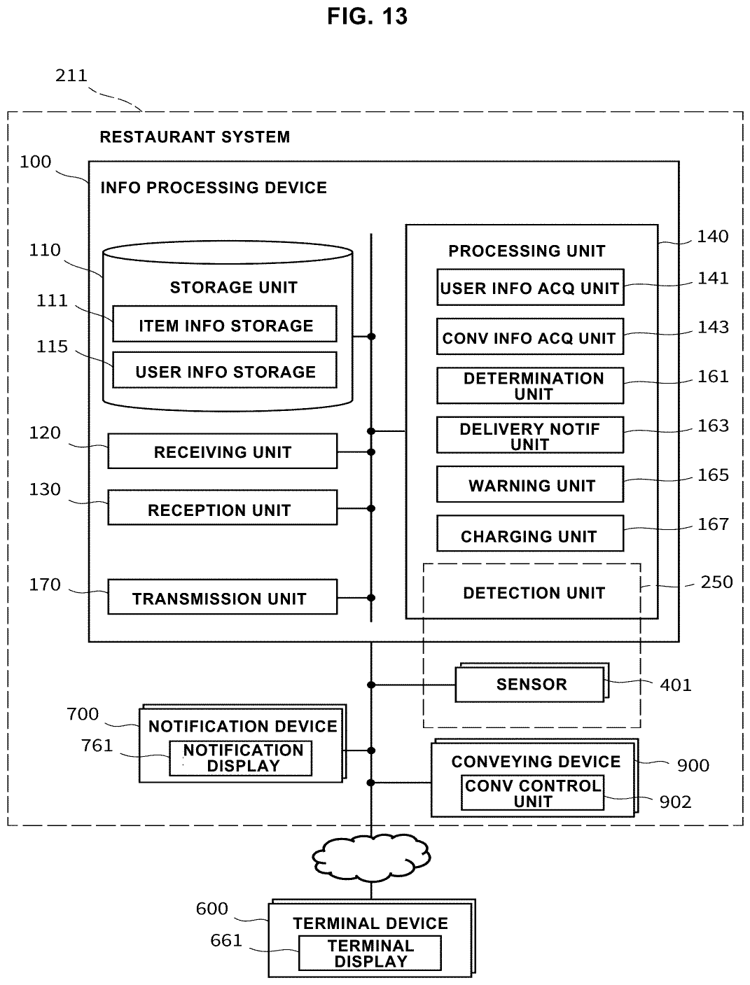

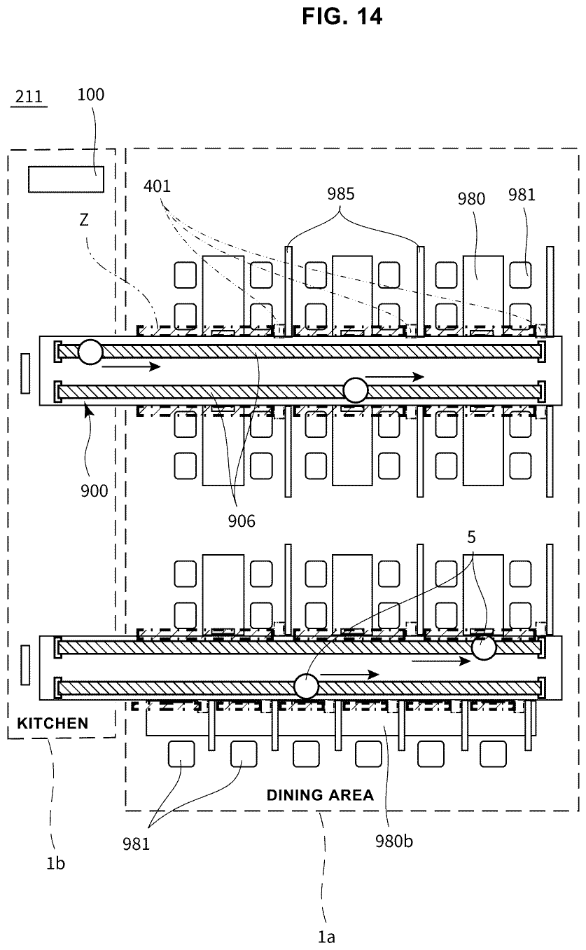

FIG. 13 is a block diagram of a restaurant system 211 according to a modification to the second embodiment. FIG. 14 is a plan view showing an overview of the restaurant system 211.

In this modification, as shown in FIG. 14, the restaurant system 211 has sensors 401 corresponding to each of seats. As shown in FIG. 13, the detection unit 250 is formed of the sensors 401 and does not include the seat identification unit 155. That is, in this embodiment, the processing unit 140 serving as the detection unit 250 can identify the seat corresponding to the sensor 401 that detects the caution state as the seat for which the caution state has occurred.

Even with this configuration, the processing unit 140 can use the detection result of the detection unit 250 to determine whether the caution condition has been satisfied or to output the caution information, and the like in the same manner as described above.

In this modified example, the sensor 401 may measure the distance to a foreign object, or may simply detect a foreign object in the detection area Z of each seat. For example, in addition to the distance measuring sensor described above, various sensors to measure physical quantity that varies by the existence of a foreign object, such as a photoelectric sensor or an infrared sensor that detects infrared rays emitted from a foreign object, may be used as sensor 401.

### Others

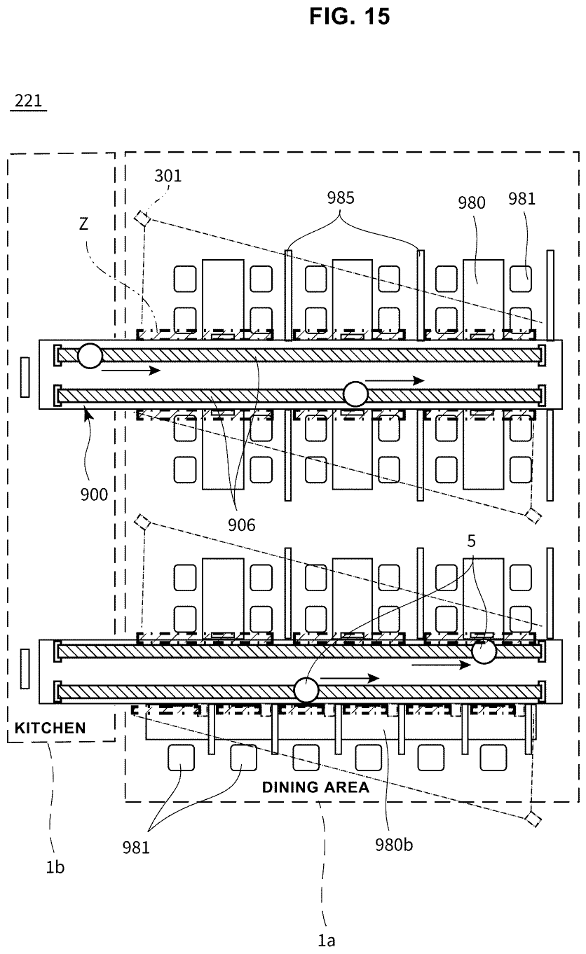

FIG. 15 is a plan view illustrating an overview of a restaurant system 221 according to one modification to the first embodiment of the present disclosure.

In the above-described embodiment 1, a camera 301 corresponding to each seat is provided in the restaurant system 1, but in this modified example, the restaurant system 221 includes cameras 301 each of which is installed to have the detection areas Z of two or more seats covered by an imaging range of the camera 301. That is, one camera is provided for two or more seats. In this way, the number of cameras 301 can be reduced.

For example, in the example shown in FIG. 15, the camera 301 is provided for each group of three seats or six counter seats that are arranged along each conveying path 906. Each camera 301 is set to cover the detection area Z of each seat in the corresponding group within the imaging range.

In this modification, the processing unit 140 of the information processing device 100 is configured so that the image determination unit 153 determines, based on the image captured by the camera 301, whether the caution state has occurred in any seat. For example, using the captured image, the caution state and its position within the angle of view are detected, and the seat for which the caution state occurred can be identified. The determination may be made using, for example, but not limited to, machine learning technique.

Even with this configuration where the number of the cameras 301 is less than the seats, the processing unit 140 can use the detection result of the detection unit 250 to determine whether the caution condition has been satisfied or to output the caution information, and the like in the same manner as described above.

In addition, the detection unit that detects the caution state may be configured to detect that the caution state has occurred at any seat or that the caution state has occurred at a particular seat by using a camera and various sensors in combination.

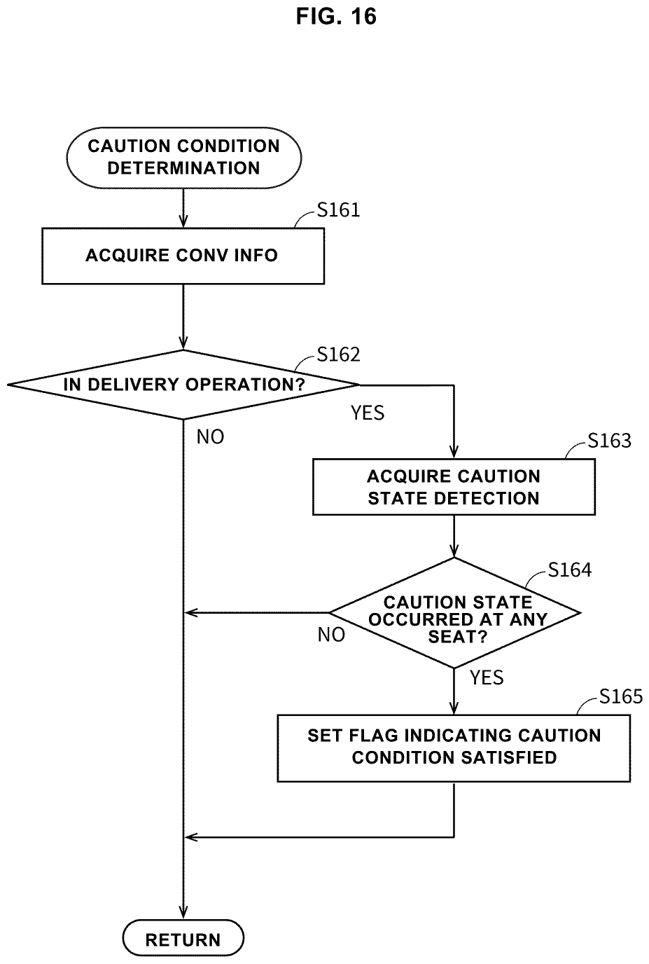

FIG. 16 is a flowchart showing another modified example of a caution condition determination process performed by the information processing device 100 according to the first embodiment of the present disclosure.

In the following modified example, it is determined that the caution condition is satisfied if the caution state is detected to have occurred in any seat during delivery. In this case, the result of detection of the caution state may be acquired only when the conveying device 900 is in operation.

(Step S161) The processing unit 140 acquires the conveyance information regarding the conveying device 900. This is the same as step S121.

(Step S162) The processing unit 140 determines whether the conveying device 900 is in operation based on the conveyance information. This is the same as step S123. If the conveying device 900 is determined to be in operation, the process proceeds to step S163, and if not, the caution condition determination process ends.

(Step S163) The processing unit 140 acquires a detection result as to whether the caution state has occurred. This is the same as step S122.

(Step S164) The processing unit 140 determines whether the caution state has occurred at any seat based on the detection result of the caution state. This is the same as step S124. If the caution condition is determined to have occurred at any seat, the process proceeds to step S165, and if not, the caution condition determination process ends.

(Step S165) In this case, it can be described that the processing unit 140 has determined that the caution condition is satisfied. The processing unit 140 stores, for example, a flag indicating that the caution condition is satisfied in the storage unit 110. Thereafter, the caution condition determination process ends.

In addition, the flowchart of this modified example may be modified so that, for example, when the caution state is determined to have occurred at any seat based on the detection result of the caution state, a determination is made as to whether the conveying device 900 is in operation.

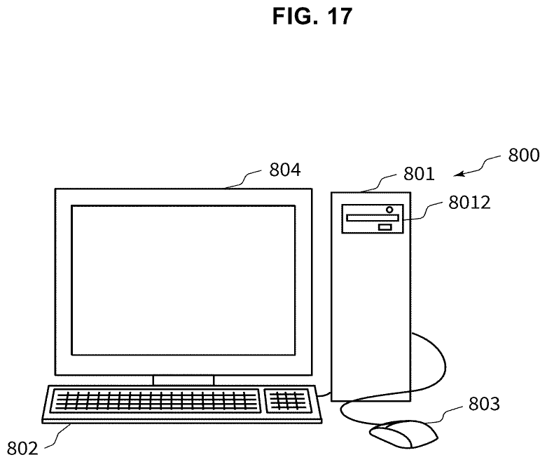

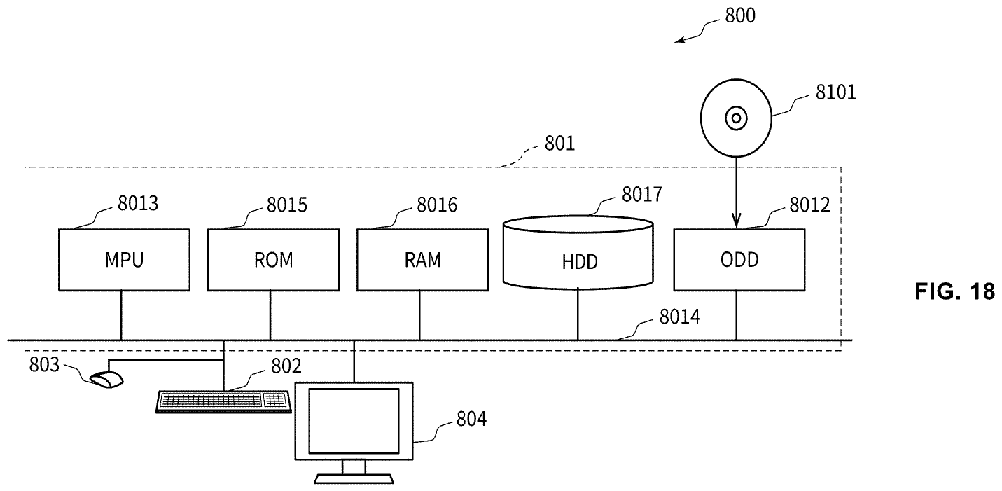

FIG. 17 is an overview view of a computer system 800 in the above embodiment. FIG. 18 is a block diagram of the computer system 800.

The figures illustrate one example of a computer that executes the program described herein to realize the information processing device 100 or the like of the restaurant system 1 of the above-described embodiment. The above embodiments can be implemented with computer hardware and a computer program running on the hardware.

The computer system 800 includes a computer 801 that includes an optical disc drive, a keyboard 802, a mouse 803, and a monitor 804.

In addition to the optical disc drive (ODD) 8012, the computer 801 is connected to a MPU8013, a bus 8014 connected to the optical disc drive 8012, etc., and a ROM8015 for storing programs such as a boot-up program MPU8013, a RAM8016 for temporarily storing instructions of an application program and providing a temporary storage space, and a hard disk (HDD) 8017 for storing an application program, a system program, and data. Although not shown herein, the computer 801 may further include a network card that provides a connection to a LAN.

A program that causes the computer system 800 to execute a function of the information processing device of the above-described embodiment may be stored in the optical disk 8101, inserted into the optical disk drive 8012, or transferred to the hard disk 8017. Alternatively, the program may be transmitted to the computer 801 over a network not shown and stored on the hard disk 8017. The program is loaded into the RAM8016 when executed. The program may be loaded directly from the optical disc 8101 or the network.

The program does not necessarily include a third-party program or an operating system (OS) that causes the computer 801 to perform functions of the information processing device or the like in the above-described embodiments. The program may include only a portion of instructions that invoke the appropriate function (module) in a controlled manner to acquire the desired result. How the computer system 800 operates is well known, and a detailed description is omitted.

In the above program, the transmission step for transmitting information, the receiving step for receiving information, and the like include processing performed by hardware, for example, a modem or an interface card in the transmission step (processing performed only by hardware).

Further, the computer that executes the program may be singular or plural. That is, centralized processing may be performed, or distributed processing may be performed.

Further, in the above embodiment, two or more components present in one device may be physically realized in one medium.

In the above embodiment, each component may be configured by dedicated hardware, or for a component that can be realized by software, such a component may be realized by executing a program. For example, each component can be realized by a program execution unit such as a CPU reading and executing a software program recorded on a recording medium such as a hard disk or semiconductor memory. At the time of execution, the program execution unit may execute the program while accessing the storage unit or the storage medium. Further, the program may be executed by downloading from a server or the like, and may be executed by reading a program stored on a predetermined storage medium (for example, an optical disk, a magnetic disk, a semiconductor memory, etc.). Further, this program may be used as a program constituting a program product. Further, the computers that execute the program may be singular or plural. That is, centralized processing may be performed, or distributed processing may be performed.

Further, in the above embodiment, each process (each function) may be realized by centralized processing by a single device (system) or may be realized by being distributed by a plurality of devices (in this case, the entire system composed of a plurality of devices that perform distributed processing may be recognized as one “device”).

Further, in the above embodiment, the transfer of information between each component may be performed, for example, when the two components that pass the information are physically different, by the output of information by one component and the reception of information by the other component. Alternatively, when the two components performing the transfer of information therebetween can be treated as the physically same, the transfer of information may be performed by shifting from the phase of processing on one component to the phase of processing on the other component.

Further, in the above embodiment, information related to the processing performed by each component (for example, information received, acquired, selected, generated, transmitted, received by each component), threshold values used by each component in processing, mathematical formulas, addresses, etc. may be stored for a long time, although not explicitly described. Further, each component or an accumulating unit (not shown) may accumulate information on the recording medium (not shown). Further, each component or a readout unit (not shown) may read out information from the storage medium (not shown).

Further, in the above embodiment, when information such as information used in each component or the like, such as threshold values, addresses, and various setting values used by each component in processing, may be changed by a user, the user may be able to change the information as appropriate, even if it is not specified in the above description. If the information can be changed by a user, the change may be realized, for example, by a non-illustrated reception unit that receives a change instruction from the user and a non-illustrated change unit that changes the information in response to the change instruction. The reception of the change instruction by the reception unit not shown may be, for example, acceptance from an input device, reception of information transmitted via a communication line, or acceptance of information read from a predetermined recording medium.

The present disclosure is not necessarily limited to the above embodiments, but can be modified in various ways, and they are also included within the scope of the present disclosure.

An embodiment may be constructed in which the components of the above-described embodiment or modifications are appropriately combined. For example, it is not limited to the configuration of the above-described embodiment itself, and each component of the above-described embodiment or modification may be appropriately substituted or combined with components such as other embodiments. Further, among the above-described embodiments and modifications, some components and functions may be omitted.

As described above, the restaurant system disclosed herein has the advantageous effects to draw attention to an abnormality in an item that is being conveyed along the conveying path, and is thus useful as a restaurant system, etc.

1. A cautioning method, comprising:
delivering an item on a conveying path of a conveying device to a target seat among two or more seats that arranged in a restaurant along the conveying path by controlling the conveying device;
outputting, in a manner corresponding to the target seat, a delivery notification indicating that the item will be delivered to the target seat presently by the conveying device;
determining whether a caution state has occurred at each of the two or more seats based on information from a sensor disposed in the restaurant, the caution state being a state where a foreign object approaches the conveying path;
determining that a caution condition is satisfied when the caution state is determined to have occurred at any seat among the two or more seats located upstream of the target seat in a conveying direction of the conveying path after the delivery notification was output; and
outputting caution information for alerting a user that an abnormality may have occurred in the item that is conveyed on the conveying path upon determining that the caution condition is satisfied.

2. A restaurant system, comprising:
a conveyance control unit that is configured to control a conveying device to deliver an item on a conveying path to a target seat among two or more seats arranged in a restaurant along the conveying path;
a detection unit that is configured to detect, at each of the two or more seats, a caution state where a foreign object approaches the conveyance path;
a determination unit that is configured to determine that a caution condition is satisfied when the detection unit detects, during delivery of the item, that the caution state has occurred at any seat among the two or more seats that is located upstream of the target seat in a conveying direction of the conveying path; and
a warning unit that is configured to output caution information for alerting a user that an abnormality may have occurred in the item that is conveyed on the conveying path when the determination unit determines that the caution condition is satisfied.

3. The restaurant system according to claim 2, further comprising
a delivery notification unit that is configured to output, in an output manner corresponding to the target seat, a delivery notification indicating that the item will be delivered to the target seat presently by the conveying device, wherein
the determination unit determines that the caution condition is satisfied when the caution state is detected at any seat among the two or more seats that is located upstream of the target seat after the delivery notification unit output the delivery notification.

4. The restaurant system according to claim 2, wherein
the determination unit determines that the caution condition is satisfied when the caution state is detected at any seat among the two or more seats and when the item is not conveyed.

5. The restaurant system according to claim 2, wherein
the detection unit detects the caution state when a foreign object enters a detection area that is defined on a side of the conveying path when viewed in the conveying direction of the conveying path.

6. The restaurant system according to claim 5, wherein
the detection unit includes a sensor that is disposed in each of the two or more seats, and
the sensor is configured to measure a physical quantity that varies by the foreign object entering the detection area.

7. The restaurant system according to claim 5, wherein
the detection unit includes:
a camera that is disposed to have the detection area of at least one of the two or more seats covered by an imaging range of the camera; and
an image determination unit that is configured to determine whether the caution state has occurred based on an image captured by the camera.

8. The restaurant system according to claim 5, wherein
the detection unit includes:
a distance measuring sensor that is disposed in association with a group including at least two seats among the two or more seats, the distance measuring sensor being configured to measure a distance to the foreign object that enters the detection area of each of the at least two seats in the group; and
a seat identification unit that is configured to identify a seat among the at least two seats where the caution state has occurred based on the distance to the foreign object measured by the distance measuring sensor.

9. The restaurant system according to claim 2, wherein
the warning unit is further configured to output the caution information in an output manner corresponding to a seat at which the detection unit detects the caution state when the detection unit detects the caution state and when the determination unit determines that the caution condition is satisfied.

10. The restaurant system according to claim 2, wherein
the warning unit is further configured to output the caution information in an output manner corresponding to the target seat when the determination unit determines that the caution condition is satisfied during delivery of the item.

11. The restaurant system according to claim 2, wherein
the warning unit is further configured to store the caution information in a storage unit in association with information for identifying a seat for which the detection unit detects the caution state when the detection unit detects the caution state and when the determination unit determines that the caution condition is satisfied.

12. The restaurant system according to claim 2, wherein
the conveyance control unit is further configured to stop delivering the item when the determination unit determines that the caution condition is satisfied during delivery of the item.

13. The restaurant system according to claim 3, wherein
the conveying device includes a delivery start button provided in a kitchen of the restaurant,
the conveyance control unit is configured to control the conveying device to start delivering the item when the delivery start button is operated, and
the delivery notification unit is configured to output the delivery notification when the delivery start button is operated.

14. The restaurant system according to claim 3, wherein
the conveying device further includes an item sensor that is disposed in a boundary portion extending into a dining area from a kitchen of the restaurant,
the item sensor is configured to detect the item when the item is conveyed into the dining area from the kitchen, and
the delivery notification unit is configured to output the delivery notification when the item sensor detects the item.

15. The restaurant system according to claim 3, wherein
the conveying device further includes a transfer conveying path that is disposed in a kitchen of the restaurant to be connected to a start edge portion of the conveying path,
the transfer conveying path is configured to transfer the item to the conveying path,
the conveying device further includes an item sensor that is configured to detect the item that is transferred from the transfer conveying path to the conveying path, and
the delivery notification unit is configured to output the delivery notification when the item sensor detects the item.

16. The restaurant system according to claim 3, wherein
the conveying device includes a weight sensor disposed in the conveying path,
the weight sensor is configured to detect the item when the item is placed on the conveying path, and
the delivery notification unit is configured to output the delivery notification when the weight sensor detects the item.

17. A restaurant processing device used in a restaurant including a conveying device that is configured to deliver an item on a conveying path to a target seat among two or more seats arranged in the restaurant along the conveying path, the restaurant processing device comprising:
at least one processor; and
at least one memory storing computer program code, wherein
the computer program code, when executed by the at least one processor, causes the at least one processor to:
determine whether a caution state has occurred at each of the two or more seats, the caution state being a state where a foreign object approaches the conveying path;
determine that a caution condition is satisfied upon determining that the caution state has occurred during delivery of the item at any seat among the two or more seats that is located upstream of the target seat in a conveying direction of the conveying path, and
output caution information for alerting a user that an abnormality may have occurred in the item that is conveyed on the conveying path upon determining that the caution condition is satisfied.

18. A non-transitory, computer readable, storage medium storing a program for a restaurant processing device disposed in a restaurant that includes a conveying device configured to deliver an item on a conveying path to a target seat among two or more seats arranged in the restaurant along the conveying path, the program, when executed by at least one processor of the restaurant processing device, causing the at least one processor to:
determine whether a caution state has occurred at each of the two or more seats, the caution state being a state where a foreign object approaches the conveying path;
determine that a caution condition is satisfied upon determining that the caution state has occurred during delivery of the item at any seat among the two or more seats that is located upstream of the target seat in a conveying direction of the conveying path, and
output caution information for alerting a user that an abnormality may have occurred in the item that is conveyed on the conveying path upon determining that the caution condition is satisfied.
